(19) United States
(12) Patent Application Publication
(10) Pub. No.: US 2018/0324288 A1
(43) Pub. Date: Nov. 8, 2018

(54) Magnetic Housing Configured for Wireless Communication

(71) Applicant: CJD LLC, New York, NY (US)

(72) Inventor: Wayne Philip Rothbaum, New York, NY (US)

(21) Appl. No.: 15/724,060

(22) Filed: Oct. 3, 2017

Related U.S. Application Data
(63) Continuation of application No. 14/750,538, filed on Jun. 25, 2015, now abandoned.
Application No. 14/750,538 is a continuation of application No. 13/093,748, filed on Apr. 25, 2011, now abandoned.
Application No. 13/093,748 is a continuation-in-part of application No. PCT/US2010/053244, filed on Oct. 19, 2010.
Application No. PCT/US2010/053244 is a continuation-in-part of application No. PCT/US2010/031087, filed on Apr. 14, 2010.

(51) Int. Cl. H04M 1/15; H04R 1/10; H04B 1/3888

(52) U.S. Cl. CPC H04M 1/15; H04R 2499/11; H04B 1/3888; H04R 1/1033

(57) ABSTRACT

The various embodiments described herein include methods and devices for housing electronic devices. In one aspect, a magnetic housing for a mobile electronic device having one or more internal antennas includes: (1) a magnetic back configured to: (a) cover at least a portion of a back of the mobile electronic device; and (b) magnetically couple with one or more magnetic attachments; (2) an encapsulating material connected to the magnetic back and configured to cover and protect the mobile electronic device; and (3) an aperture configured to expose a camera lens of the mobile electronic device; where the encapsulating material is configured to cover the one or more internal antennas while the mobile electronic device is enclosed in the housing; and where the magnetic back is configured so as to not cover the one or more internal antennas while the mobile electronic device is enclosed in the housing.

### TECHNICAL FIELD

The disclosed embodiments relate generally to magnetic housings for electronics, including, but not limited to, magnetic housings configured for wireless communication.

### BACKGROUND

Many portable electronic devices (e.g., as mobile phones, audio players, video players, etc.) generate audio output. To maintain privacy (e.g., for phone calls, etc.) and/or to improve user experience (e.g., for music and/or video playback, for noisy environments, etc.), a user may choose to use headphones. Although some portable electronic devices support wireless headphones that receive audio signals wirelessly (e.g., Bluetooth, etc.), many users of electronic devices still use wired headphones that receive audio signals through an audio cord connected to an audio port of the portable electronic device. Unfortunately, wired headphones can become easily tangled when the portable electronic device is not being used. For example, the cord of the wired headphone may become tangled when the portable electronic device is stored in a bag or a purse. Similarly, other electronic devices may use video cables, audio cables, and/or power cords that present similar cord management issues to the user.

One solution to this problem is to detach the cord of the wired headphone from the portable electronic device and to store the wired headphones separately. For example, the wired headphones may be stored in a special pouch or container. Similarly, the cord of the wired headphones may be wrapped around itself so that the cord does not become tangled. However, detaching the cord from the portable electronic device is cumbersome because the cord must be reattached (and possibly removed from a container or unwound) prior to being able to use the wired headphones with the portable electronic device. Furthermore, the headphones may become lost or may be forgotten if the headphones are detached from the portable electronic device.

Another solution to this problem is to wrap the cord of the wired headphones around the portable electronic device without detaching the cord from the portable electronic device. However, the cord of the wired headphone may become unwrapped and tangled. Furthermore, although the cord may be organized when it is wrapped around the portable electronic device, once the cord is detached from the portable electronic device, the cord may become unwrapped.

Thus, a cord management system that solves the aforementioned problems is desirable.

### SUMMARY

Some embodiments provide a case for an object. The ease has a front, a back, a bottom, a top, a first side, and a second side. In some embodiments, substantially all of the case is made of magnetic material.

In some embodiments, the magnetic material is magnetic metal, such as SAE 1008 steel; an alloy of iron, cobalt, and/or nickel; and/or SAE Type 416 stainless steel.

In some embodiments, the case has a bumper to at least partially prevent a surface of the object from contacting the magnetic material of the case. In some embodiments, the bumper is disposed between the case and an object when the object is in the case. In some embodiments, the object is a mobile electronic device.

In some embodiments, at least a portion of the case comprises a color-changing material that changes color when subjected to different environmental conditions. In some embodiments, the majority of the back of the case comprises a color-changing material. In some embodiments, the case includes designs that incorporate color-changing materials.

In some embodiments, the color-changing material is a thermochromic material that changes color due to a change in temperature of the thermochromic material. In some embodiments, the thermochromic material is a thermochromic coating, paint, and/or film. In some embodiments, the thermochromic material includes thermochromic liquid crystals and/or leuco dye. In some embodiments, the case includes an insulator between the thermochromic material and the object within the case. In some embodiments, the color-changing material is photochromic material, such as a photochromic coating, paint, and/or film.

In some embodiments, at least a portion of the back of the case is made of a magnetic material, and at least a portion of at least one of the front, bottom, top, first side, and second side is made of one or more non-magnetic materials.

Some embodiments provide a decorative skin for a mobile electronic device case. The skin includes a sheet with a first side and a second side, where the first side has magnets and/or magnetic materials for removably attaching the sheet to a case for a mobile electronic device that has a magnetic material component. The skin also includes a second side with a decoration, such that when the sheet is removably attached to the case, the decorative treatment is presented to a user. In some embodiments, the sheet has one or more through-holes. In some embodiments, the decoration comprises a thermochromic material, a photochormic material, a metameric material, a color, and/or a design.

Some embodiments provide a method of manufacturing a case for a mobile electronic device. The method includes providing one or more color-changing materials that change color when subjected to different environmental conditions, providing one or more non color-changing materials, forming one or more color-changing portions of a case, forming one or more non color-changing portions of a case, and creating a case for a mobile electronic device incorporating the one or more color-changing portions and the one or more non color-changing portions.

Some embodiments provide a method of manufacturing a case for a mobile electronic device. The method includes providing one or more color-changing materials that change color when subjected to different environmental conditions, providing one or more non color-changing materials, and forming a case for a mobile electronic device including the color-changing and the non color-changing materials.

Some embodiments provide a method of manufacturing a case for a mobile electronic device. The method includes providing a case for a mobile electronic device, and applying to at least a portion of the case a color-changing material that changes color when subjected to different environmental conditions.

Some embodiments provide a method of manufacturing a case for an electronic device. The method includes providing a case for a mobile electronic device, applying a thermochromic coating to at least a portion of the case, and applying an ultra-violet radiation inhibiting coating over at least a portion of the thermochromic coating. In some embodiments, at least a portion of the case is black, and the thermochromic coating is applied over at least a portion of the black portion of the case. In some embodiments, a clear coating is applied over at least a portion of the ultra-violet radiation inhibiting coating.

In some embodiments, the cases are manufactured with metameric materials.

### BRIEF DESCRIPTION OF THE DRAWINGS

FIGS. 1A-1L illustrate a case with a magnetic material, according to some embodiments.

FIGS. 2A-2L illustrate another case with a magnetic material, similar to those in FIGS. 1A-1L, according to some embodiments.

FIG. 3 is a flowchart of a method for manufacturing a cord management system, according to some embodiments.

FIG. 4 is a flowchart of method for manufacturing another cord management system, according to some embodiments.

FIG. 5 is a flowchart of a method for manufacturing another cord management system, according to some embodiments.

FIG. 6 illustrates a case including color-changing material on a portion of the case, according to some embodiments.

FIG. 7 illustrates a case with a thermochromic material, according to some embodiments.

FIG. 8 illustrates a case with a design incorporating thermochromic materials, according to some embodiments.

FIG. 9 illustrates a case where portions of the case include thermochromic materials, according to some embodiments.

FIG. 10 illustrates a case with a design incorporating thermochromic materials, according to some embodiments.

FIG. 11 illustrates a partial cross-sectional view of a portion of a case, according to some embodiments.

FIG. 12A illustrates a case with a thermochromic sheet, according to some embodiments.

FIG. 12B illustrates a partial cross-sectional view of a portion of a thermochromic sheet, according to some embodiments.

FIG. 13 is a flowchart of another method for manufacturing a case with a color-changing material, according to some embodiments.

FIG. 14 is a flowchart of a method for manufacturing a case with a color-changing material, according to some embodiments.

FIG. 15 is a flowchart of a method for manufacturing a case with a thermochromic material, according to some embodiments.

FIG. 16 is a flowchart of a method of using a case that includes a color-changing material.

FIG. 17 is a flowchart of a method for manufacturing a decorative sheeting with a color-changing material, according to some embodiments.

Like reference numerals refer to corresponding parts throughout the drawings.

### DESCRIPTION OF EMBODIMENTS

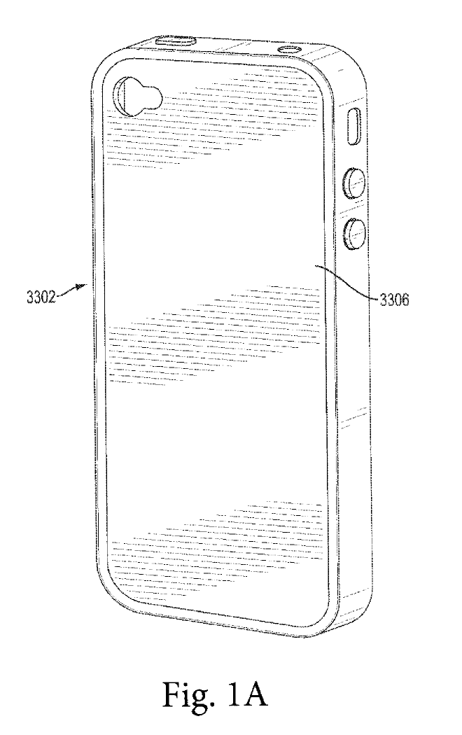

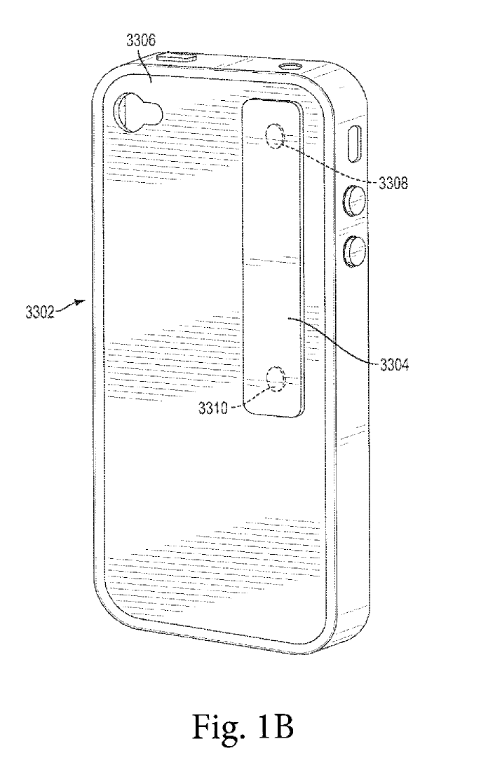

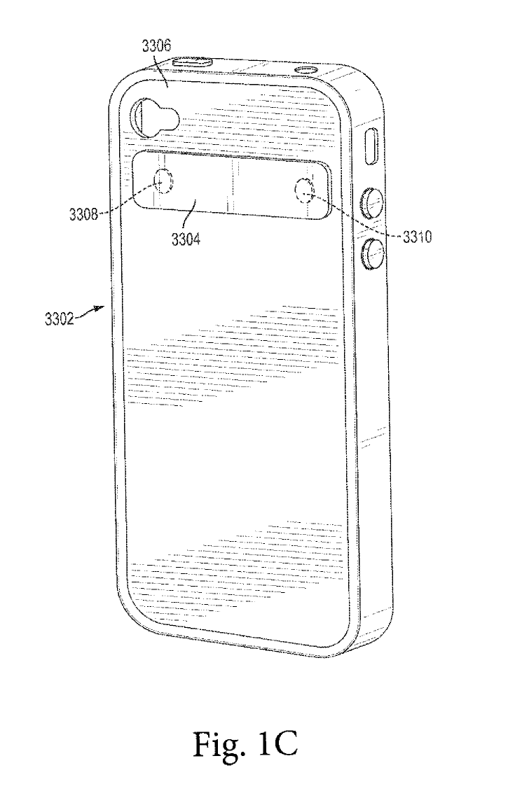

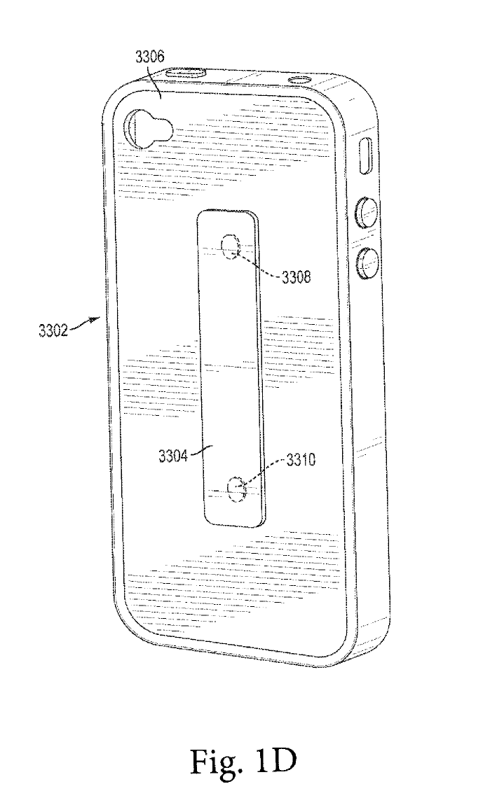

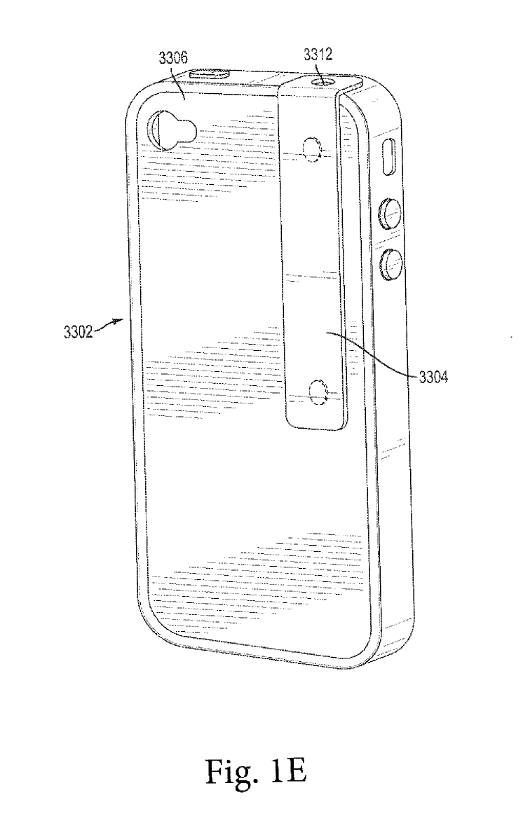

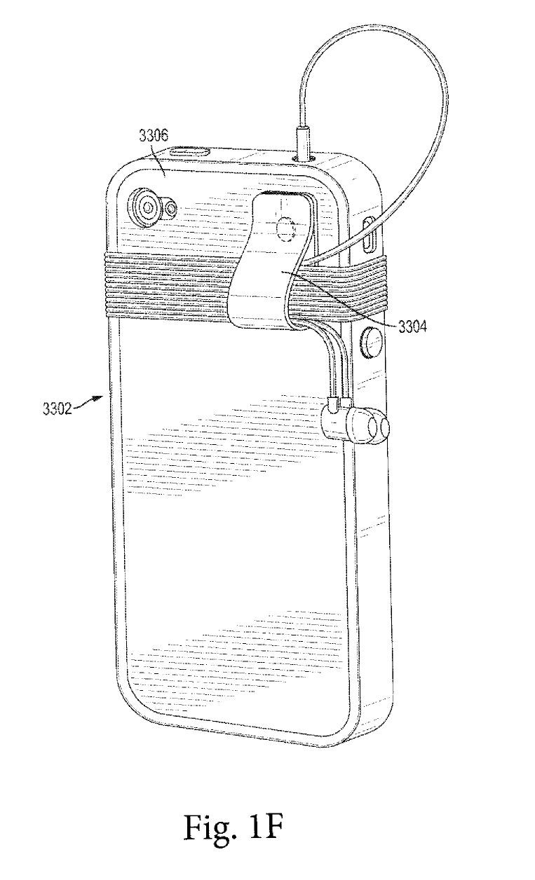

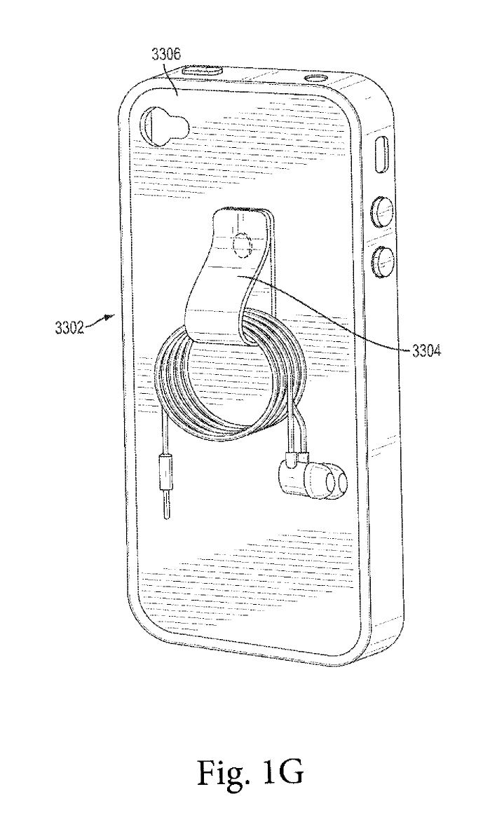

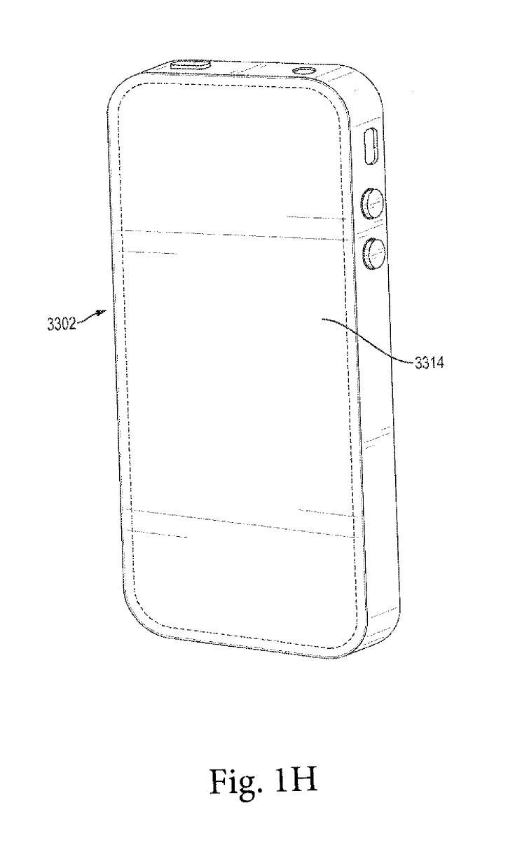

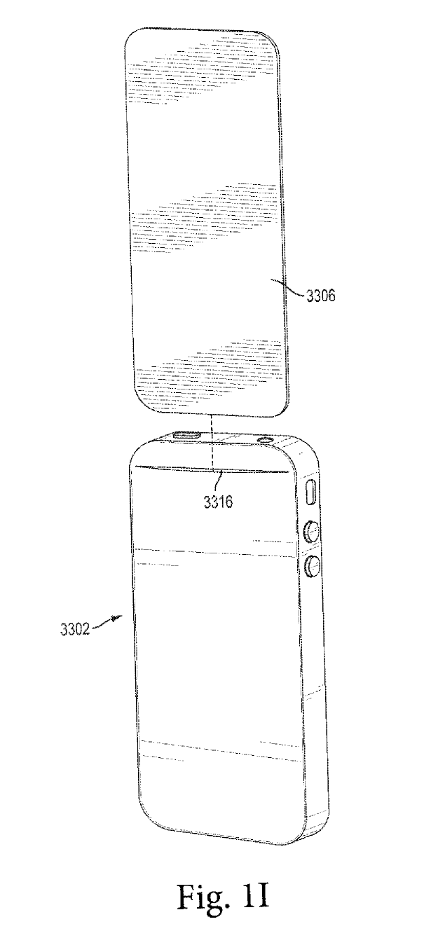

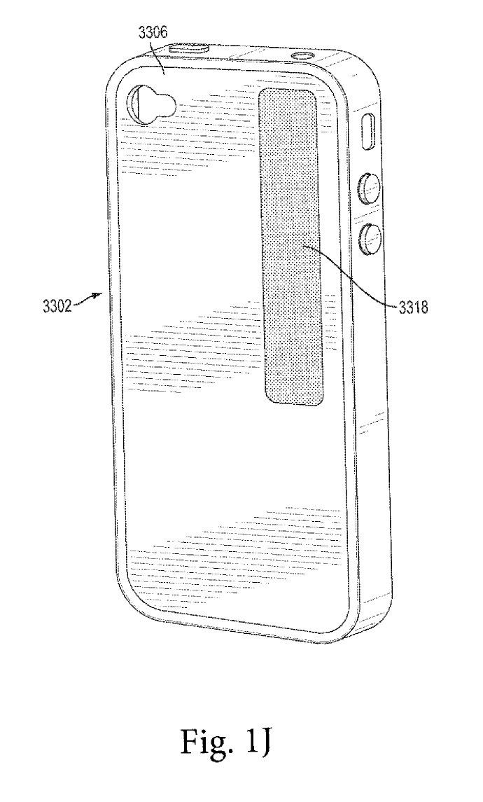

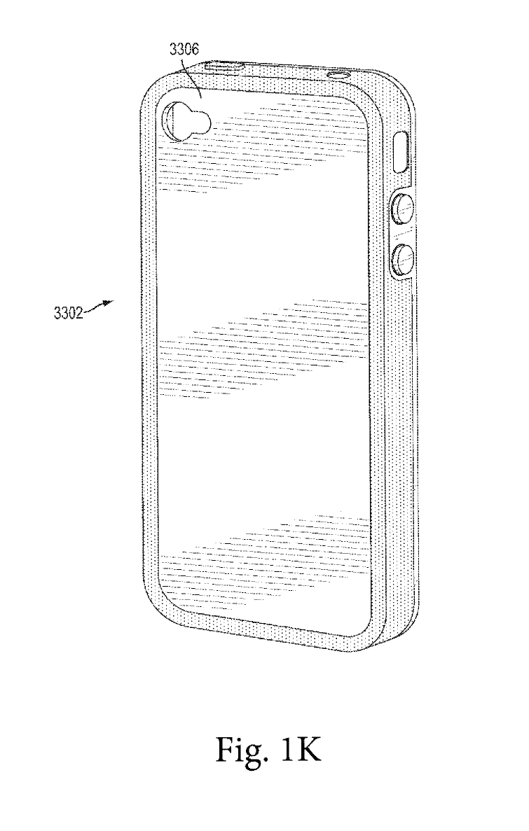

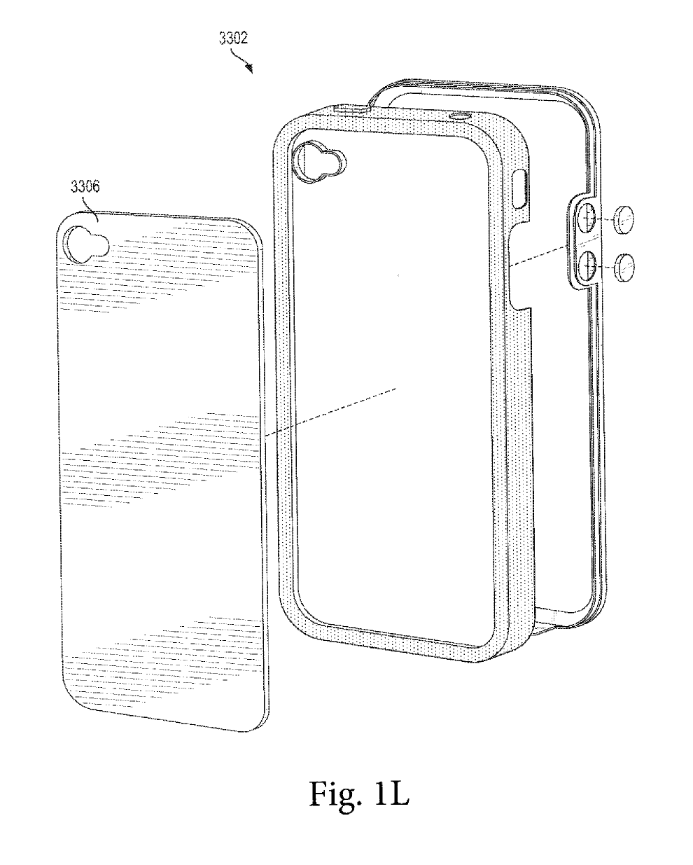

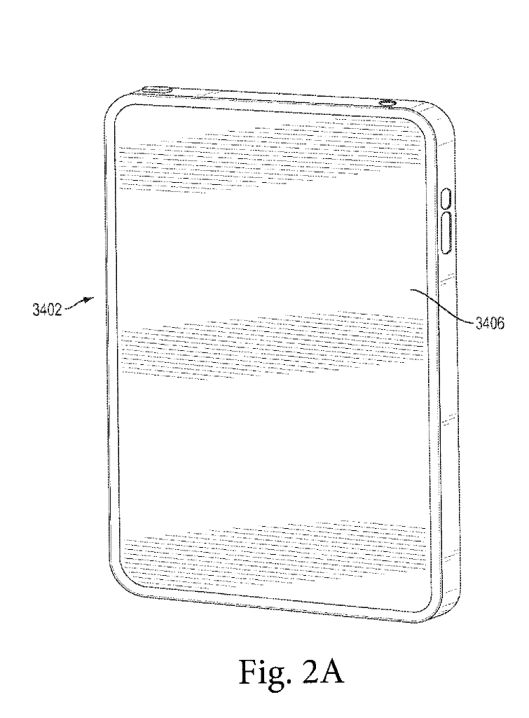

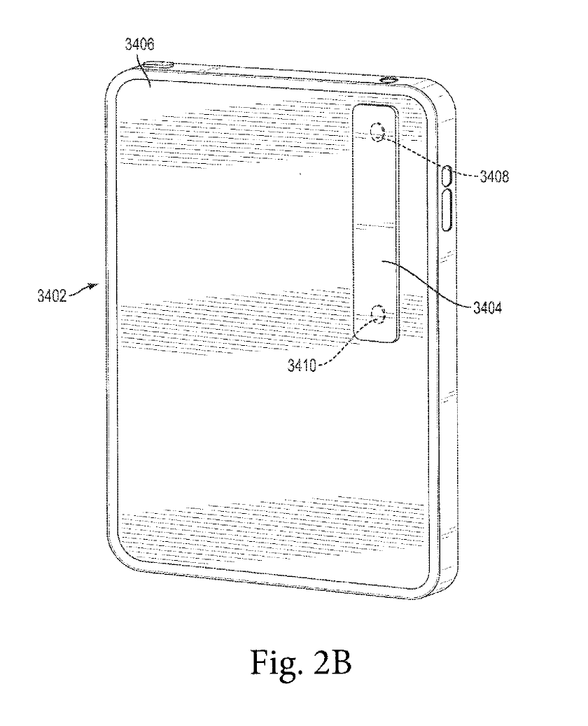

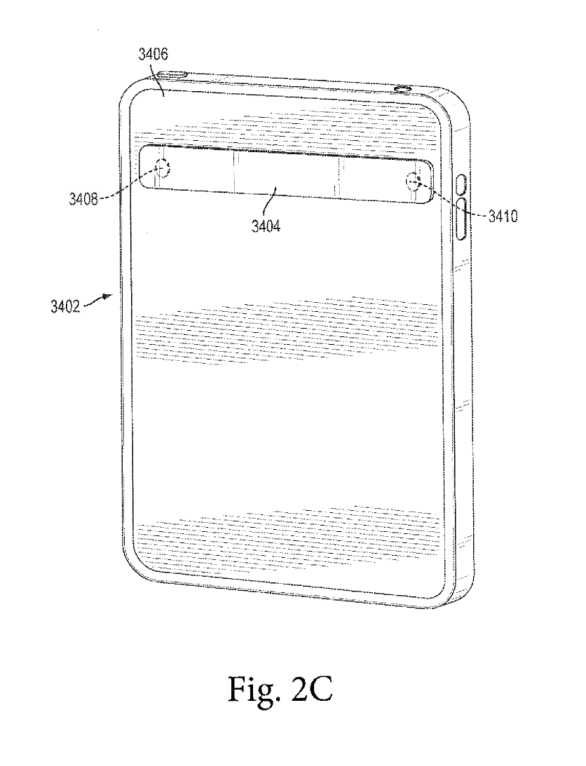

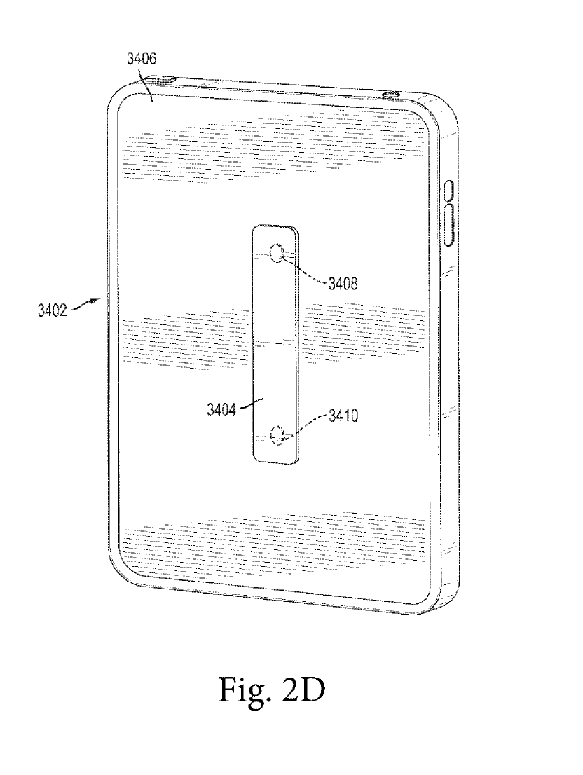

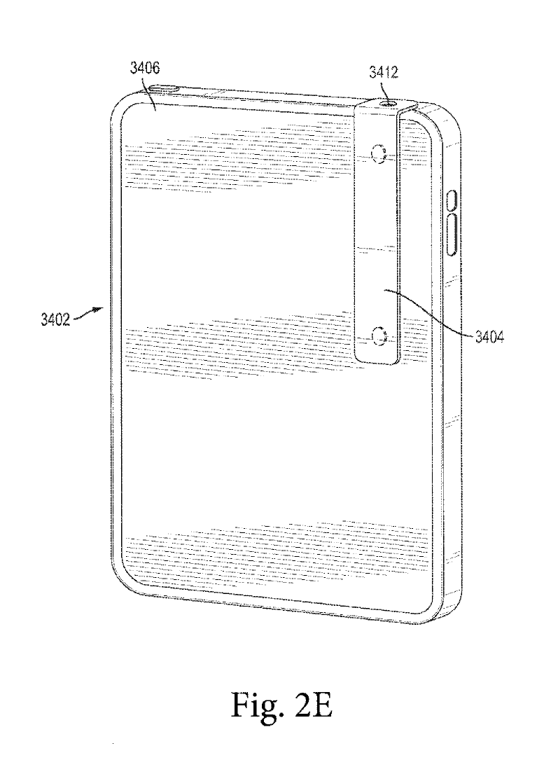

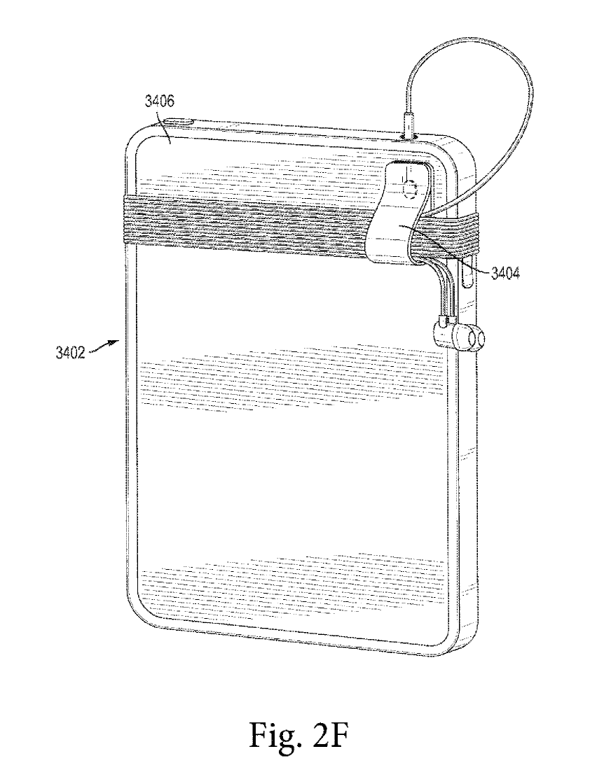

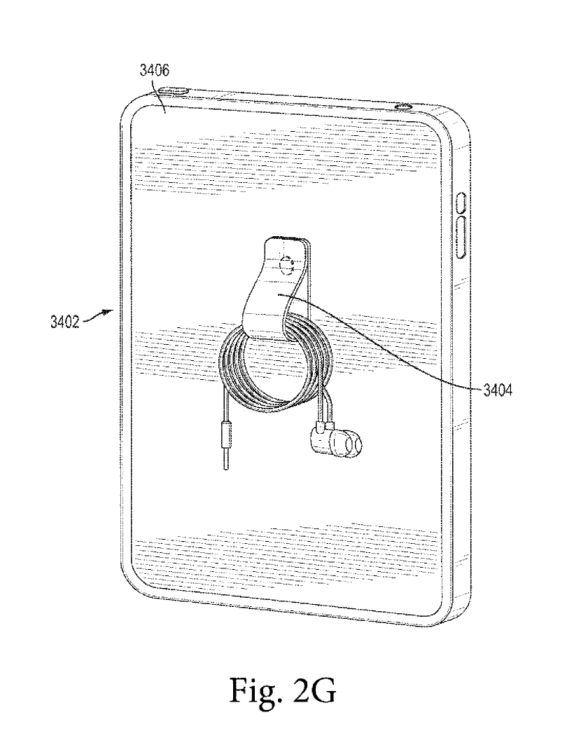

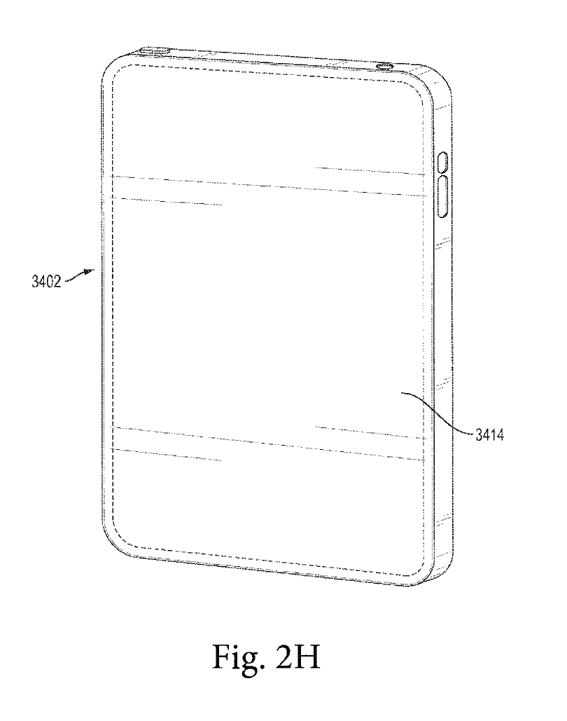

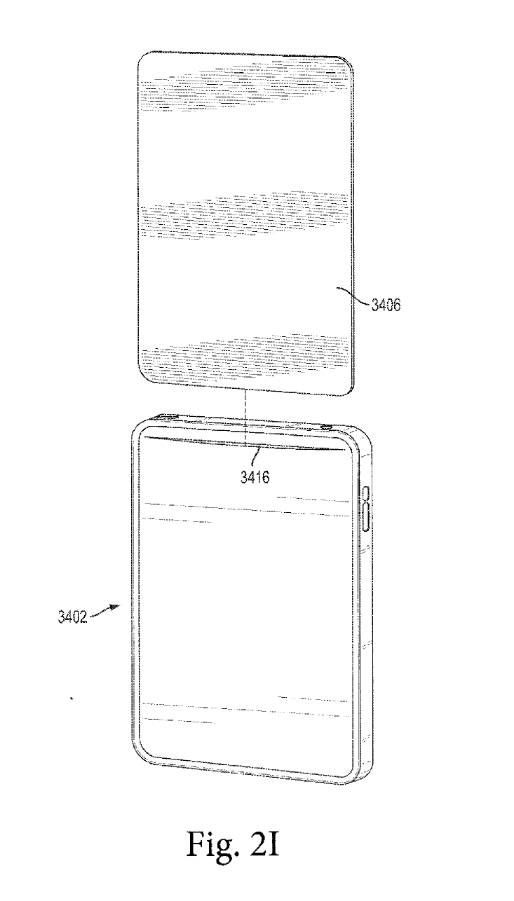

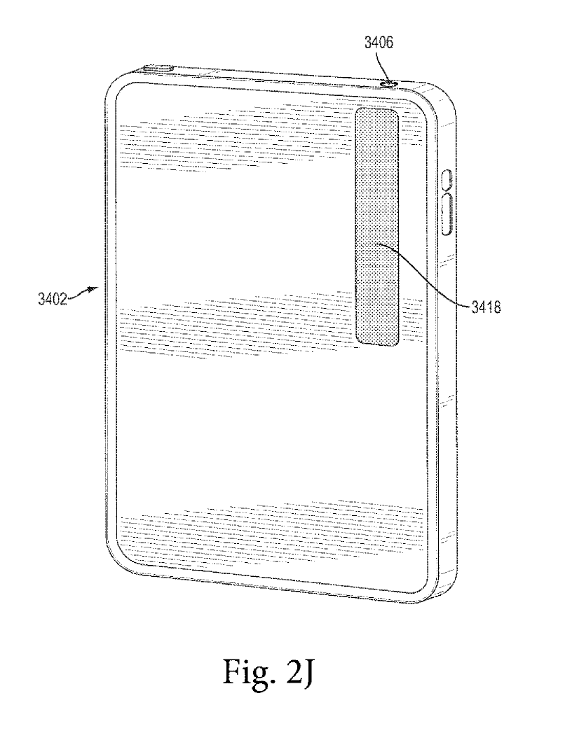

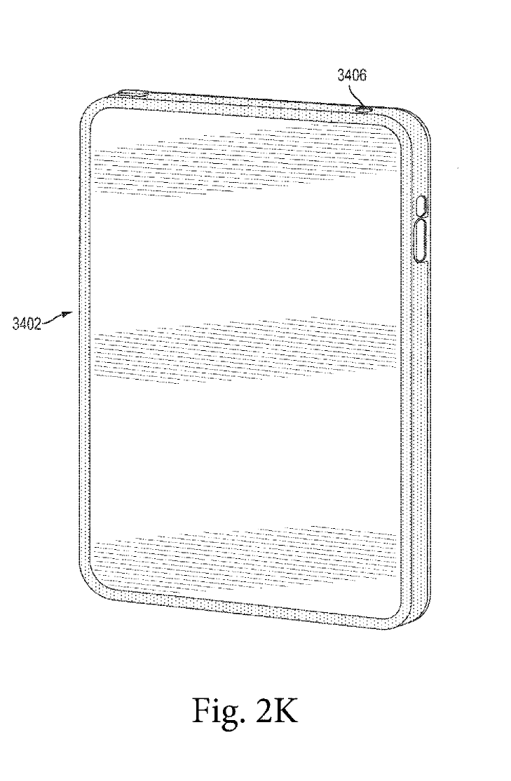

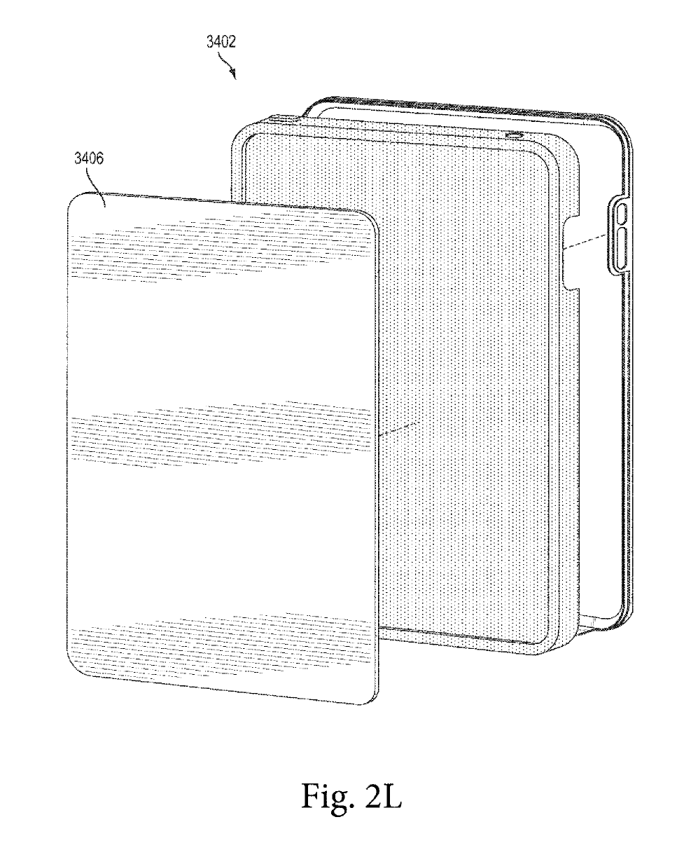

FIGS. 1-2 illustrate various embodiments of a case for an object. FIGS. 1A-1L illustrate embodiments of a case 3302 that can be paired with a removable, detachable, or semi-permanent strap. FIG. 1A illustrates the case with a back 3306 made of a magnet or of a magnetic material, referred to herein as a magnetic material back 3306. The magnetic material back 3306 can be made of any ferromagnetic material and/or paramagnetic material. In some embodiments, the magnetic material is low-carbon steel. In some embodiments, the magnetic material is Vanadium carbonyl. In some embodiments, the magnetic material back 3306 is made of a pliable material such as rubber, silicone, an elastomer (e.g., thermoplastic elastomer), or other pliable materials discussed above, wherein the pliable material encapsulates small magnets or magnetic material elements within it. For example, in some embodiments the back is made of an elastomer or paint with iron flecks in it. It should be noted that although the back is discussed in detail herein, other portions of the case may also be made of a magnet or magnetic material. For example, in some embodiments, substantially all of the ease, including the sides and front, is made of a metal magnetic material (with the exception of portions near or over a device's antenna). In some embodiments, all of the case is made of a magnetic material, such as a magnetic metal. Furthermore, in some embodiments only a portion of the back of the case includes the magnetic material back 3306. For example, in alternative embodiments the magnetic material back 3306 covers only three-quarters, half, one quarter, or less of the back of the object. A more detailed description of the straps that can be used with the disclosed embodiments can be found in U.S. patent application Ser. No. 14/750,538, filed on Jun. 25, 2015, entitled “Case with a Removable Magnetic Material Back for a Mobile Electronic Device,” which is hereby incorporated by reference in its entirety.

In some embodiments, the case includes a bumper to at least partially prevent a surface of the object (contained within the case) from contacting the magnetic material of the case. When substantially all of a case is made of metal, it may be advantageous to include a bumper or padding on the portions of the case that contact or interface with the object within the case. The bumper can reduce the likelihood that the metal case will scratch, scrape, and/or score the surface of an object within the case. In some embodiments, the bumper can act as an impact buffer, reducing the likelihood of damage to an object should the case be dropped when it is holding the object. In some embodiments, the bumper is a piece of foam, rubber, plastic, fabric, and/or leather on a surface of the case, and configured to be disposed between the case and the object when the object is in the case.

The case 3302 with the magnetic material back 3306 allows a user to position a strap on any desired portion of the magnetic material back that the user desires, like magnets on a refrigerator door. In other words, as long as the strap includes at least one magnet, the strap can be placed in any position on the magnetic material back 3306. For example, FIG. 1B illustrates a strap 3304 in a position to facilitate retaining a cord wrapped horizontally around the case. Alternatively, the strap 3304 can be placed horizontally on the magnetic material back 3306 as shown in FIG. 1C, which would facilitate retaining a cord wrapped vertically around the case. Furthermore, as shown in FIG. 1D, the strap 3304 can also be positioned in the middle of the magnetic material back 3306. A variety of other positions of the strap should be apparent to one of skill in the art.

Another advantage of a case 3302 with a magnetic material back 3306 is that various types of the straps can be equally well accommodated. For example, FIG. 1E shows a strap 3304 including a cord-attachment mechanism 3312, used in conjunction with the magnetic material back 3306. Whereas FIG. 1B shows a strap 3304 that does not include a cord-attachment mechanism also used in conjunction with the magnetic material back 3306.

Furthermore, not only can the strap 3304 be positioned by a user such that it neatly holds a wrapped cord when the cord is attached to an object as shown in FIG. 1F, but this design also allows a user to position the strap 3304 in optimal positions for holding the cord when it is not attached to the object. For example, the user may place the strap 3304 in the middle of the magnetic material back 3306 for holding an unplugged looped cord, as shown in FIG. 1G.

In some embodiments, the magnetic material back 3306 is exposed as shown in FIG. 1A, while in other embodiments the magnetic material back 3306 is encapsulated in an encapsulating material 3314 as shown in FIG. 1H. In some embodiments, the encapsulating material 3314 is pliable material such as rubber, leather, plastic, polymer, fabric (silk, cotton, denim, foil, Mylar, Neoprene fabric), etc. In other embodiments, the encapsulating material 3314 is a rigid material such as glass, plastic, metal, mirrored material, etc. In some embodiments, the encapsulating material is waterproof and/or scratch resistant. The encapsulating material 3314 may also protect the metal back while also holding it in place. In some embodiments, the encapsulating material is made of a non-skid type surface (i.e. the material has a high coefficient of friction) such as rubber or silicone to assist the user in holding the object. Alternatively, in some embodiments the encapsulating material has a relatively low coefficient of friction such as leather or plastic in order to allow the case to slide easily into and out of a pocket. Some embodiments include a combination of the above mentioned encapsulating materials on different portions of the case 3302 (as discussed in more detail with respect to FIGS. 1K and 1L). Furthermore, in some embodiments the materials are made of different colors. The different colored portions of the case may add aesthetic appeal to the case, and may serve to distinguish the various portions of the case from one another. In some embodiments, the magnetic material back 3306 is held in place by a rim of encapsulating material stretched around the edge of the magnetic material back 3306. In other words, in these embodiments, the encapsulating material does not cover the back, but instead frames it.

In some embodiments, rather than having an encapsulating material 3314 over the magnetic material back 3306, the magnetic material back 3306 is covered with a coating material such as an opaque or translucent paint, polyurethane, scratch resistant gloss, etc. In some embodiments, the coating is applied directly to the surface of the back prior to the back being joined to the case 3302. In some embodiments, while the coating may protect the back, it does not necessarily hold it in place in the same manner as the encapsulating material. As such, in some embodiments, a portion of the case 3302 is molded over the magnetic material back 3306 such that the magnetic material back 3306 is held in place. For example, in some embodiments, the rim of case 3302 that contacts the magnetic material back 3306 is made of an elastomer material such as rubber or silicone that is molded over the edges of the magnetic material back 3306.

In other embodiments, rather than being over molded, melted, welded, or otherwise permanently attached to the case 3302, the back is slidably connected to the case 3302. For example, in some embodiments, the magnetic material back 3306 fits into a pocket 3316 or tracks in the case 3302 as shown in Figure II. This figure illustrates the magnetic material back 3306 in a position to be inserted into the pocket 3316 to clearly illustrate the pocket element of this embodiment, although when in use the magnetic material back 3306 would be slid entirely or substantially entirely into the pocket 3316. In some embodiments, the back might also slide into place from a side opening pocket rather than the top opening pocket shown in FIG. 1I. Furthermore, in some embodiments, the pocket 3316 itself has one or more holes exposing the back. For example, in some embodiments the pocket 3316 includes a large hole making the pocket more like a picture frame encapsulating the magnetic material back 3306, wherein the magnetic material back 3306 is slid into tracks in the pocket or frame. In other embodiments, the pocket 3316 will include one or two large sides to keep the magnetic material hack 3306 more firmly in place, as shown in FIG. 1I. For example, the pocket may include an external transparent plastic side, which can he seen through, and which does not significantly diminish the magnetic properties of the magnetic material back 3306, but which holds the magnetic material back 3306 of the case firmly against the object's back. This transparent plastic side also protects the hack from scratches and may also be waterproof.

In some embodiments, as shown in FIG. 1J, one portion 3318 of the magnetic material back 3306 is distinct from the rest of the back. In some embodiments, the portion 3318, is covered in a heartier covering that is more resistant to scratches such as a polymer coating, a translucent paint, polyurethane, a scratch resistant gloss, etc. Additionally or alternatively, in some embodiments the portion 3318 is painted or dyed a different color from the rest of the magnetic material back 3306 to show the ideal spot for the strap 3304 to be attached or for decorative purposes. In some embodiments, the portion 3318 includes a slight indentation (similar to the cavities described above) to indicate a suggested spot for the magnetic strap to attach. Similarly, in some embodiments, the portion 3318 includes a slight raised area to indicate a suggested spot for the magnetic strap to attach. In some embodiments, the portion 3318 is made of one or more magnets, while the remainder of the magnetic material back 3306 is made of a magnetic material.

In some embodiments, the portions of the case excluding the magnetic material back 3306, is made of one or more non-magnetic materials. For example, portions of the case can include a pliable material, which will help facilitate the insertion of an object into the case, especially in embodiments where the magnetic material back 3306 of the case 3302 is rigid. In some embodiments, the remainder of the case is made of a combination of pliable materials and rigid materials. For example, as shown in FIG. 1K, portions of the band surrounding the top, bottom, and side edges of the object are made of pliable or stretchable material such as a rubber material, while other portions are made of a rigid material such as a plastic material. FIG. 1L illustrates the different portions of this embodiment in an exploded view, which further illustrates which portions of the case 3302 are made of plastic (or similar non-magnetic rigid materials) and which are made of silicone/rubber (or similar non-magnetic pliable materials).

FIGS. 2A-2L illustrate embodiments of a case similar to FIGS. 1A-1L with the exception that the object for which the case is made has different dimensions than the object shown in FIGS. 1A-1L.

In some embodiments, the case at least partially covers the back side of an object when the object is located within the case. In any of the embodiments described herein, the case can be made of any suitable material such as leather, plastic, rubber, fabric, polymer, metal, etc. In polymer embodiments, the polymer is selected from the group consisting of silicone and an elastomer (e.g., thermoplastic elastomer). In some embodiments, the polymer is resistant to dust. These polymers may be used in manufacturing processes such as injection molding, casting, compression molding, and die cutting. In fabric embodiments, the fabric may be a Neoprene fabric, leather, silk, cotton, denim, foil, Mylar, and the like. The fabric case will likewise be manufactured by any suitable sewing or joining technique, depending on the fabric chosen.

In some embodiments, a combination of the above mentioned materials will be used to cover various portions of the case. For example, as discussed in more detail with respect to FIGS. 1A-1L and 2A-2L, in some embodiments the case will be a combination of plastic, metal, rubber and/or silicone. In some embodiments, at least a portion of the case includes a non-skid material in order to facilitate easy gripping by the user. In some embodiments, at least a portion of the case is made of a slippery material having a lower coefficient of friction than another portion of the case, in order to allow the case to slide easily into and out of a pocket. Furthermore, in embodiments including metal, at least the portion of the case covering the object's antenna (if any), will not be made of metal. In some embodiments, the case will also include a separate finish, such as a painted finish, a scratch resistant finish, a mirrored finish, etc.

The elastic polymers embodiments of the case may be manufactured by processes such as injection molding, casting, compression molding, and die cutting. The type of manufacturing process selected may depend on factors such as a desired manufacturing volume, manufacturing time, and manufacturing costs of the case. Additionally, the type of manufacturing process selected may depend on a desired aesthetic design of the case. For example, in some embodiments, a two-shot injection molding process is used.

The magnets of the case may include any element or composition that is capable of producing a magnetic field. For example, the magnets may include one or more of magnetic metallic elements (e.g., iron, cobalt, nickel, etc.), composite magnets (e.g., ceramic or ferrite magnets, alnico magnets, ticonal magnets, injection molded magnets, flexible magnets), rare earth magnets (e.g., samarium-cobalt magnets, neodymium-iron-boron magnets, etc.), electromagnets, sets of any of these magnets, or any material or composition that produces a magnetic field. Examples of metals that are (or are capable of being) magnetic include, but are not limited to: ferritic stainless steels; martensitic stainless steels; SAE 400 series stainless steels (e.g., SAE Type 416 stainless steel); SAE 1000-9000 series steels (e.g., SAE 1008 steel); alloys of nickel, iron, and/or cobalt; and/or iron.

In some embodiments, the magnets are Neodymium magnets. In some embodiments, the Neodymium magnets are a grade N42. In some embodiments, the magnets are solid magnets. In some embodiments, the magnets are selected from the group consisting of donut (ring) magnets, horseshoe-shaped (U-shaped) magnets, cylindrical magnets, disc-shaped magnets, rectangular magnets, and the like. In some embodiments, the magnets are sets of magnets. The selection of the size, shape, and number of the magnets may depend on factors including, but not limited to, a desired magnetic strength, a desired form factor, a desired aesthetic, and the manufacturing process used to produce the strap.

Although not required, one or more of the case “magnets” can be made of a magnetic material rather than a magnet. The magnetic material can be made of any material that produces a magnetic field in response to an applied magnetic field. In some embodiments, the magnetic material is selected from the group consisting of a ferromagnetic material and a paramagnetic material. In some embodiments, the magnetic material is low-carbon steel. In some embodiments, the magnetic material is Vanadium carbonyl. The magnetic material may be any shape, including, but not limited to, a disc, a square, a rectangle, a decorative shape, and the like. The size and shape of the magnetic material may be selected based on factors including, but not limited to, an aesthetic design of the case and strap. Furthermore, as described in more detail, with respect to FIGS. 1A-1L, the entire case back, or a portion thereof, can be made of a magnetic material.

In some embodiments the case includes holes for object elements such as speakers, a dock/charger connector, a camera/lens, an LED/flash, a ringer mode switch, an on/off switch, etc. In some embodiments, one hole will accommodate more than one element. For example, a large bottom hole is configured to expose the dock/charger connector and the speakers. Similarly, a single back hole is configured to expose the LED/flash and the camera/lens. Alternative embodiments will provide differently shaped holes such as a larger and/or differently shaped hole for the LED/flash and camera/lens and a larger and/or differently shaped hole for the dock/charger connector and the speakers. Similarly, in other embodiments, separate holes are provided for each of the LED/flash and the camera/lens. Likewise, in some embodiments, separate holes are provided for each of the speakers and the dock charger. In some embodiments holes will also be provided for access to volume buttons. The exact dimensions and placement of the holes is determined based on the specific requirements of the object inserted into the case. For example, in cases designed to house an object with a track wheel (e.g., a track wheel for a thumb placed on the side of the object), a track wheel hole is also included in the case. Similarly, for objects that include a touch screen or touch sensitive area for controlling the object's functions, holes will be provided to access these elements as well. In some embodiments, a large hole is provided in the front of the case for viewing the screen (whether touch sensitive or otherwise). In some embodiments, the front of the ease may include a transparent screen cover. In some embodiments, the camera hole may include a small built in lens to improve the quality of pictures taken with the object's built-in camera lens. In some embodiments, the edges of the holes are beveled, re-enforced with a stronger material, or covered with a protective coating. These additions allow the holes to withstand greater wear and tear during use than the case could otherwise withstand. In some embodiments, the case may include a hole to allow a support stand element to pass through the case.

In some embodiments certain elements, such as buttons, rather than just being available through a hole as described above, are instead covered. In some embodiments, the button covers are made of a pliable material such as rubber or silicone. In other embodiments, the button covers are made of a rigid material such as plastic or metal. Any of the above mentioned materials discussed with respect to the case may be used for the button covers. The button covers keep the object within the cover more protected from dirt, debris, and moisture which could otherwise accumulate. Furthermore, the button covers protect the buttons from scratches. Similarly, in some embodiments, the holes for the camera, LED/flash, and screen are covered with a transparent material such as glass or transparent plastic to similarly protect the device. In some embodiments, the button covers are recessed with respect to the exterior surface of the case, such that the button covers do not stick out past the profile of the case, and are thus less likely to be inadvertently pressed. In other embodiments, the button covers are not recessed with respect to the exterior surface of the case. It should be noted that in some embodiments, the button covers are colored differently from the case in order to make them easier for a user to locate, and to add to the aesthetic appeal of the case.

In some embodiments, at least a portion of a cord management system includes a color-changing material that changes color when it is subjected to different environmental conditions. Color-changing materials can be employed in order to give an item, such as a case or strap for a cord management system, an attractive, decorative appearance. As described in greater detail below, color-changing materials can be designed or selected in order to display dynamic color schemes on the case. For instance, when a user holds a mobile electronic device case that incorporates a thermochromic material, the heat from a user's hand may cause a handprint to appear on the case in a distinct color (or colors) from other portions of the case. Also, in some embodiments, the case is configured so that a user can use a finger, flashlight, laser, heat pen, heat brush, or other object to “draw” on the case. The various uses and applications for a case with a color-changing material can add an element of novelty and attractiveness to the cord management system, and can increase the appeal and entertainment value of such cases. Also, thermochromic materials are used in some embodiments to provide information to a user of a device, for example by indicating a temperature of a device. Color-changing materials, including thermochromic materials, are disclosed in greater detail herein.

In some embodiments, a cord management system includes a case for a mobile electronic device. Mobile electronic devices include any of a class of electronic devices that are small and light enough to be easily transported with a person. A mobile electronic device is a self-contained electronic device which usually has one or more of: a screen, buttons, a touch screen, a keyboard, a speaker, a lens, and a microphone. They are often battery powered, and often include electronic components (e.g., batteries, processors, memory, circuit boards, and the like) surrounded by a cover or housing. In some embodiments, a mobile electronic device is an audio player, a portable video player, a handheld gaming system, a navigation device, a tablet computer, a laptop computer, an e-book reader, a personal digital assistant, a camera, a camcorder, and/or a handheld video projector. Mobile electronic device cases are often used to protect, cover, and/or accessorize mobile electronic devices.

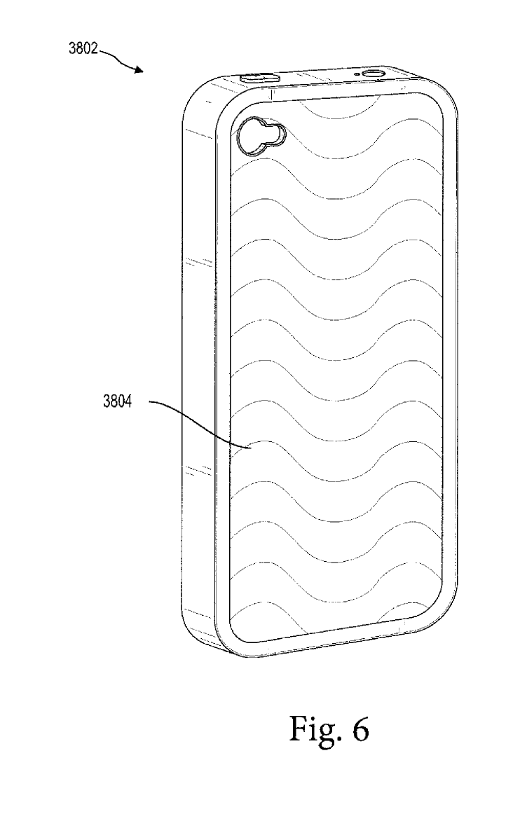

FIG. 6 illustrates a case 3802 that includes a color-changing material on a portion 3804 of the case, according to some embodiments. The color-changing material is indicated by wavy lines. In this embodiment, the color changing portion 3804 is the back of the case 3802. In some embodiments, other portions of the case 3802 may include color-changing material. For example, in some embodiments, the entire case 3802 includes color-changing material. In some embodiments, one or more edges of the case 3802 include color-changing material. In some embodiments, one or more buttons or button covers on the case 3802 include color-changing material.

In some embodiments, the color-changing material is a thermochromic material. Thermochromic materials are materials that change color due to changes in the temperature of the material and/or the environment surrounding the material. In some embodiments, the color-changing material is a photochromic material. Photochromic materials change color due to a change in the wavelength and/or intensity of light incident on the material. Photochromic materials are discussed in greater detail herein. As used herein, a change in color corresponds to any change in hue, brightness, shade, tint, and/or saturation that is detectable by the human eye. In some embodiments, a change in color of a material corresponds to a change from one Pantone color standard to another Pantone color standard. In some embodiments, a color changing material will change to (or will transition between) a first color (e.g., black) and a second color (e.g., green). In some embodiments, a color changing material will transition between additional colors, for example, changing between black and green and purple and blue.

In some embodiments, other coatings or materials that provide interesting or decorative visual characteristics are used. For example, in some embodiments, materials that exhibit geometric metameric failure are used. Such materials appear to a viewer to be different colors depending on the viewing angle, the viewing distance, and/or the lighting angle. As used herein, materials exhibiting geometric metameric failure (including paints, coatings, dyes, etc.) are referred to as metameric materials.

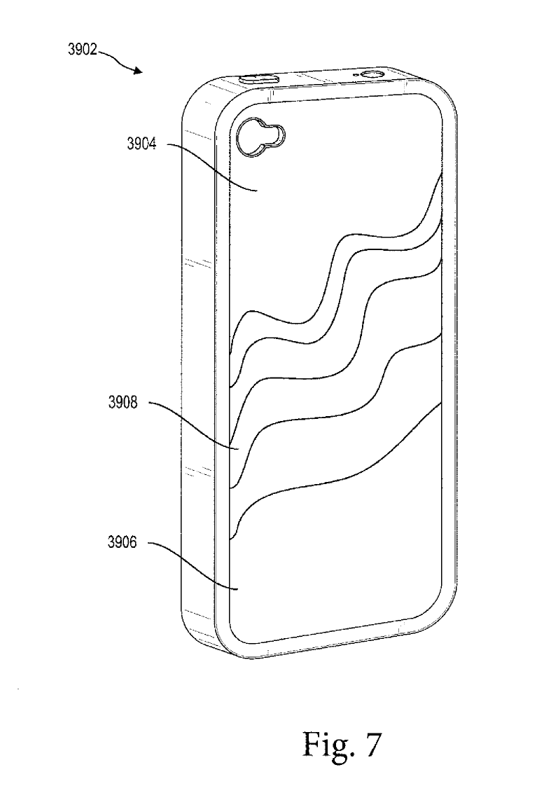

Attention is now drawn to FIG. 7, which illustrates a case 3902 that includes a thermochromic material according to some embodiments. The case 3902 shows the case 3902 in a state when more than one color is visible. As shown in FIG. 7, the case 3902 shows a first portion 3904 of the case that is a first color, a second portion 3906 of the case that is a second color, and a third portion 3908 of the ease that is an intermediate color (or a plurality of intermediate colors). In some embodiments, the first, second, and third portions of the case correspond to different temperatures. For example, in some embodiments, the first portion 3904 of the case corresponds to a first temperature, such as a temperature around 70 degrees Fahrenheit, while the second portion 3906 of the case corresponds to a second temperature which is higher than the first temperature, such as a temperature around 95 degrees Fahrenheit. Also, the third portion 3908 of the case, corresponding to the intermediate (or plurality of intermediate colors) corresponds to temperatures between 70 and 95 degrees Fahrenheit. The lines between the first and second portions of the case shown in FIG. 7 are intended merely as a functional illustration the color-changing properties of a case in accordance with some embodiments, and are not intended to show exact color boundaries or temperature gradients.

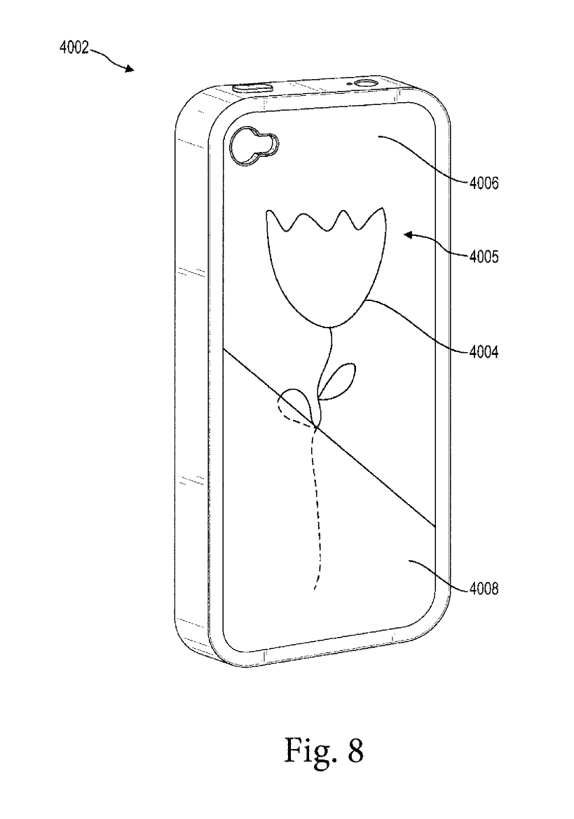

In some embodiments, a color-changing material is incorporated in a case in such a way that a design becomes visible or not visible (or less visible) only when certain environmental conditions exist. FIG. 8 illustrates a case 4002 where a design 4004 is incorporated in a thermochromic material on the case 4002, according to some embodiments. The design 4004 is set against a background 4005. In some embodiments, the background 4005 refers to an area of the case that is near or adjacent to the design. In some embodiments, at least part of the design 4004 is thermochromic material. In some embodiments, at least part of the background 4005 is thermochromic material. In some embodiments, both the design 4004 and the background 4005 include some portions that are thermochromic material.

FIG. 8 shows how the design 4004 may be visible on a portion of the case having a first temperature, and not visible (or less visible) on a portion of the case having a second temperature. For example, FIG. 8 shows a first portion 4006 of the case and a second portion 4008 of the case. The first portion 4006 corresponds to the case 4002 having a first temperature, where the design 4004 is visible as indicated by the solid lines of the design 4004. The second portion 4008 corresponds to the case having a second temperature, where the design 4004 is not visible (or less visible) as indicated by the dashed lines of the design 4004. A user could cause the design 4004 to appear or disappear, for example, by using his or her hand to heat up such a case.

In some embodiments, the design 4004 is made of (or includes) a color-changing material that is the same color as the background 4005 when the color-changing material is subject to a first environmental condition, and is a different color from the rest of the case when the background 4005 is subject to another environmental condition. Thus, the design 4004 will appear to be the same color as the background 4005 (i.e., not visible or less visible) or appear to he a different color than the background 4005 (i.e., visible) based on the specific environmental condition of the color-changing material. On the other hand, in some embodiments, the background 4005 is made of (or includes) a color-changing material that is the same color as the design 4004 when the color-changing material is subject to a first environmental condition, and is a different color from the design 4004 when the case is subject to another environmental condition. In some embodiments, both the design 4004 and the background 4005 are made of (or include) a color-changing material. In these embodiments, the color changing materials each display different colors at different environmental conditions, and/or different colors at the same environmental conditions.

In the foregoing description, the flower design is merely exemplary, and the design could be any design. In some embodiments, the design is any of: representational designs (e.g., flowers, animals, faces), non-representational designs (e.g., dots, lines, patterns), and informational designs (e.g., words, logos, trademarks).

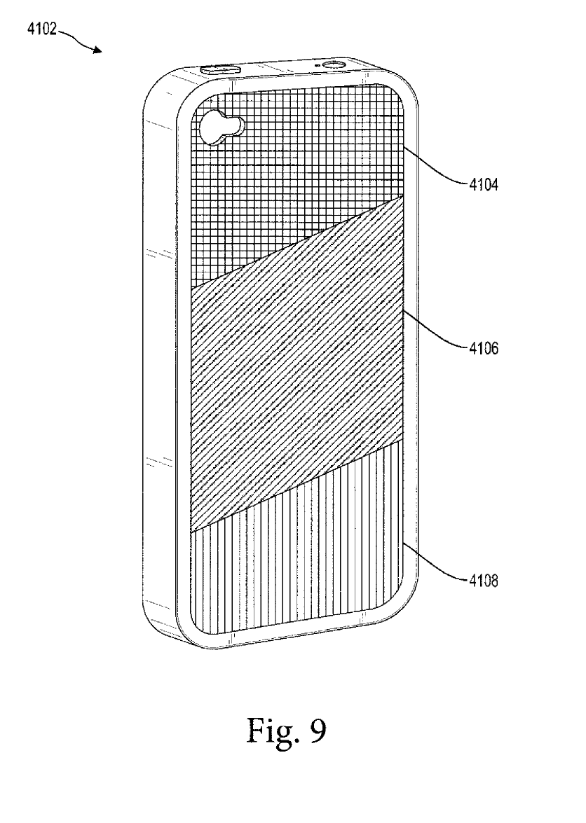

FIG. 9 illustrates an embodiment where different portions of the case 4102 include different color-changing materials. The first portion 4104 includes a first color-changing material, the second portion 4106 includes a second color-changing material, and the third portion 4108 includes a third color-changing material. In some embodiments, the three portions each display a different color from one another when the case 4102 is at a first environmental condition. In some embodiments, the three portions each display a different color from one another when the case 4102 is at a second environmental condition. In some embodiments, each portion of case 4102 displays one color at the first environmental condition, and another color at the second environmental condition. In some embodiments, thermochromic material is used so that the portions of the case change color in response to different temperatures. For example, in some embodiments, at a first temperature, the first portion 4104 is red, the second portion 4106 is green, and the third portion 4108 is blue. At a second temperature, the first portion 4104 is orange, the second portion 4106 is yellow, and the third portion 4108 is black. In some embodiments, only two portions of the case 4102 include color-changing materials, while in other embodiments, three or more portions of the case include color-changing material.

In some embodiments, the color-changing material is a thermochromic material that is configured to change color in response to a temperature change caused by the device within the case. For example, mobile electronic devices often heat up when they are in use, such as when a user is making a telephone call on a mobile telephone. In some cases, the increased temperature of the device (and the case holding the device) is caused by the heating up of a battery during use. Thus, for example, a case can be designed for a mobile electronic device where the thermochromic material is designed to change color in accordance with the increased battery temperature typical for that device.

In some embodiments, a case includes a design that displays certain colors, symbols, and/or designs to indicate the temperature of the device. Such a design may provide a user with other information about the device as well. For example, since the temperature of a battery powered electronic device may increase over a period of time, the temperature of the device (and accordingly of a case holding the device) may be used as a proxy for the duration that a device has been in use. Thus, a thermochromic material is sometimes used to indicate how long a user has been using an electronic device.

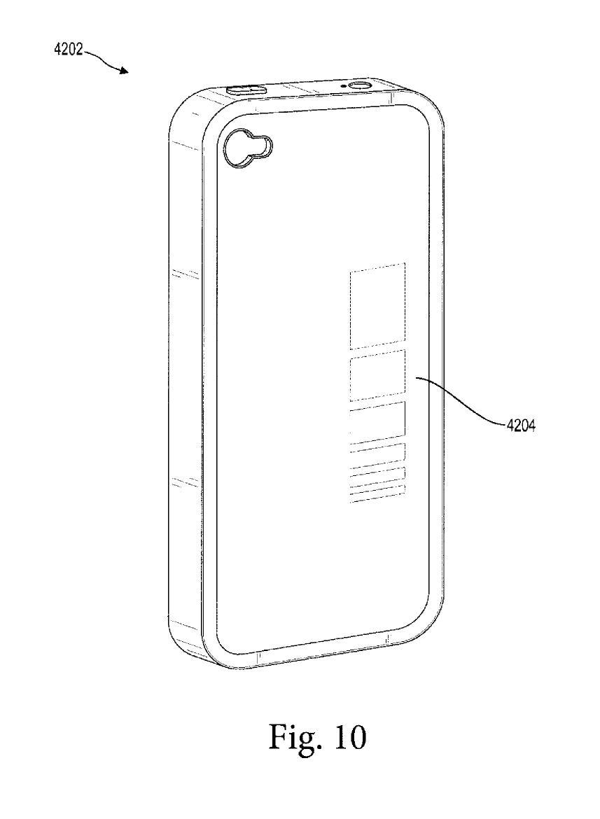

FIG. 10 illustrates a case 4202 including a design 4204, according to some embodiments. In some embodiments, the design 4204 is a temperature indicating design that illustrates the temperature of the device, and therefore, in some embodiments, the duration that a device has been in use. The design 4204 in FIG. 10 uses shapes of increasing size to indicate increased device temperature, although any suitable differentiation could be used. The design 4204 is shown when the case 4202 is in an intermediate temperature state. At this state, the first three bars are visible as indicated by the solid lines, and the two largest bars (indicating a higher temperature) are not visible, as indicated by the dashed lines. Thus, the design 4204 may indicate a certain temperature of the device, and thus indicate to a user how long the device has been in use.

Throughout the present discussion, the different designs and colors that are incorporated into a case may be selected based on design preferences, material constraints, and/or desired operating temperatures. Furthermore, specific temperature ranges in which designs and colors are displayed may be subject to particular design choices. These design choices are all considered to be within the scope of the invention. For instance, in some embodiments, a design may be visible at a higher temperature and not visible (or less visible) at a lower temperature. Alternatively, a design may be visible at a lower temperature and not visible (or less visible) at a higher temperature. In some embodiments, a case can be configured to display multiple different designs based on different temperatures of combinations of temperatures.

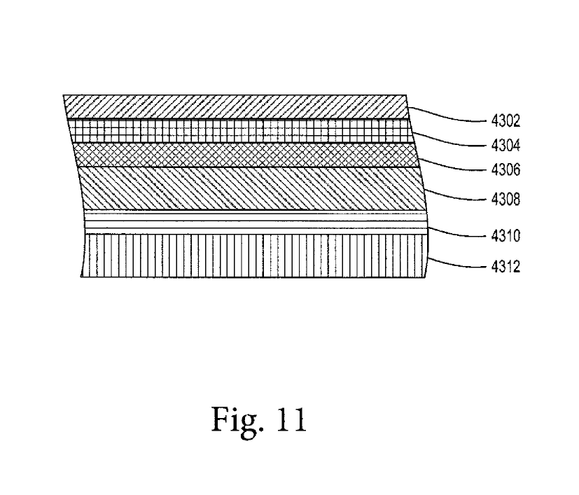

In some embodiments, it is preferable that the heat produced by the electronic device does not cause a thermochromic material to change color. For instance, in some embodiments the heat of a user's hand is the main cause of a color change on a case. Also, in some embodiments, a case may incorporate a temperature indicating design for indicating the temperature of the air surrounding the case. Accordingly, it may be beneficial for the portion of the case comprising thermochromic material to be least partially thermally insulated from the electronic device within the case in order to limit the effect of a battery's heat on the thermochromic material. Insulating materials are discussed in greater detail herein with reference to FIG. 11.

FIG. 11 illustrates a partial cross-sectional view of portion of some embodiments of a case. In some embodiments, the case includes a protective coating 4302, an ultra-violet radiation inhibiting coating 4304, a color-changing material 4306, a magnetic material portion 4308, a polymer portion 4310, and an insulating element 4312.

In some embodiments, the protective coating 4302 is an at least semi-transparent coating, painting, covering, sealer, film, sheet, and/or finish. The protective coating 4302 is sometimes designed to help prevent scratches, dents, or other damage to an underlying layer (e.g., the color changing material 4306, an alternative paint layer, and/or a magnetic material portion 4308). In some embodiments, the protective coating 4302 helps prevent underlying layers from peeling and/or flaking. In some embodiments, the protective coating 4302 includes the ultra-violet inhibiting coating 4304, or otherwise includes an ultra-violet radiation inhibiting material. In these embodiments, the two coatings may only be a single layer of material. In some embodiments, the protective coating 4302 is urethane, polyester, lacquer, epoxy, resin, plastic, and/or glass.

The color-changing material 4306 is a material that changes color when subjected to different environmental conditions, as described in more detail below. The color-changing material 4306 is, in some embodiments, a thermochromic material, a photochromic material, or a metameric material. In some embodiments, the color-changing material 4306 is a paint, coating, and/or film layer component of a case. Also, the color-changing material 4306 is substituted with a standard, non-color-changing material in some embodiments.

In some embodiments, the ultra-violet radiation inhibiting coating 4304 prevents or limits the transmission of ultra-violet radiation to subsequent layers or coatings of the case. In some embodiments, the color-changing material 4306 degrades when exposed to ultra-violet radiation, resulting in diminished color changing properties. In some embodiments, other colors, paints, and/or designs fade when exposed to ultra-violet radiation. Thus, ultra-violet radiation inhibiting coating 4304 helps limit the damaging effects of ultra-violet radiation.

In some embodiments, a case includes a magnetic material portion 4308 and a polymer portion 4310. The specific materials for a case in accordance with embodiments of the present invention are discussed in greater detail elsewhere in this application, and will not be discussed in detail here.

In some embodiments, the insulating element 4312 is an insulator such as glass, fiberglass, plastic, elastomer, and/or rubber. In some embodiments, a case is configured such that an air gap exists between the thermochromic material and a device within the case. The air gap insulates the device from the thermochromic material, and can be used in addition to or instead of the insulating element 4312. Thus, in some embodiments, the case does not include an insulating element 44312.

In some embodiments, the insulating element 4312 is a portion of a case that has a color-changing material. For example, a plastic or polymer case may have a color-changing paint on an outer surface, and the plastic or polymer that makes up the case may act as an insulating element.

It is understood that not all of the materials or components illustrated in this cross section are necessarily used in all embodiments of the present invention. For example, some embodiments of a case do not include magnetic materials. Furthermore, additional components not identified or discussed here may likewise be incorporated without departing from the spirit of the invention.

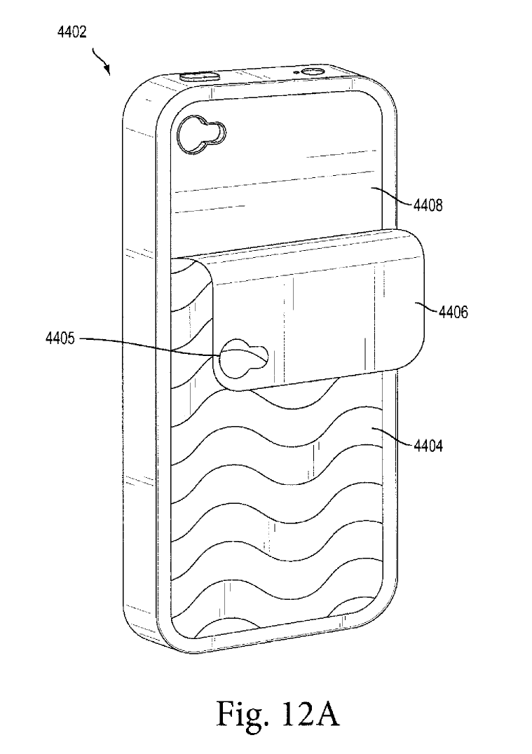

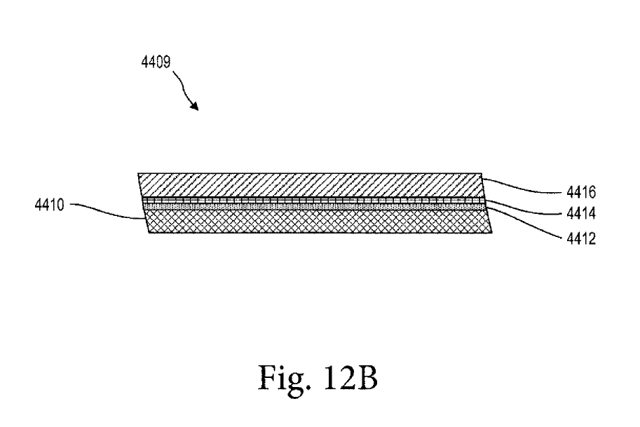

In some embodiments, a color-changing material is incorporated in a skin that is applied to a portion of the case. FIG. 12A illustrates a case 4402 with a decorative skin 4404, where the skin 4404 is partially attached to the case 4402. In some embodiments, the skin 4404 is applied to a portion of the case using magnets, adhesives, or other embedding or coating methods. In some embodiments, the skin 4404 includes a magnet or magnetic material 4406 that can removably attach the skin 4404 to a case for a mobile electronic device that has a magnetic material back. In some embodiments, the skin 4404 is incorporated into the case such that it is not easily or conveniently removed. For instance, the decorative skin 4404 can be permanently or semi-permanently applied to a case for a mobile electronic device. For example, the skin 4404 is sometimes glued or adhered to the case with adhesives, adhered to the case using a static force, or applied to the case and then securely covered by a coating.

In some embodiments, the decorative skin 4404 further comprises one or more edges defining through-holes 4405 between the first and second sides, wherein the one or more through-holes 4405 are configured to allow optical access through the skin 4404 by a component of the mobile electronic device. For example, the through-holes are sometimes positioned so that a lens and/or a flash component of a mobile electronic device are not covered by the skin.

In some embodiments, at least a portion of the non-contacting side of the skin includes a thermochromic material. In some embodiments, the skin does not include a thermochromic material, but has another design and/or decoration instead. Designs may include, but are not limited to, representational designs, non-representational designs, and informational designs. Such designs may include a color, word, picture, photograph, outline, shape, image, and/or logo. In some embodiments, decorative skins include a magnet or magnetic material 4406 as an attachment mechanism allowing them to attach to and decorate and/or personalize a case for an object. In some embodiments, the case has a magnetic material surface such as a magnetic material back, and skins are magnetically attached to the case via the magnetic material surface. In some embodiments, the attachment mechanism is selected from any of: adhesive, Velcro, van der Waals force attachment mechanisms (e.g., Gecko tape), and suction devices (e.g., suction cups). In some embodiments, the skins are permanently attached to the case (e.g., with an adhesive).

In some embodiments, a color-changing material is incorporated into a decorative sheeting material. In some embodiments, the decorative sheeting material is permanently or semi-permanently incorporated into a case for a mobile electronic device. FIG. 12B illustrates a partial cross sectional view of a portion of some embodiments of a decorative sheeting 4409. The decorative sheeting 4409 includes a first layer comprising a first substrate 4410. The first substrate 4410 is made of any suitable substrate material, including but not limited to plastic and/or polymer films, such as polyester films (e.g., Mylar). The decorative sheeting 4409 includes a second layer comprising a second substrate sub-layer 4416 and a color-changing material sub-layer 4412 that changes color when subjected to different environmental conditions. In some embodiments, the color changing material sub-layer 4412 includes thermochromic liquid crystals. The first layer and the second layer are layered with respect to one another such that the color-changing material sub-layer 4412 is between the first substrate 4410 and the second substrate 4416. In some embodiments, the second layer includes an ultra-violet radiation inhibiting material sub-layer 4414. In some embodiments, the ultra-violet radiation inhibiting material sub-layer 4414 is oriented between the second substrate sub-layer 4416 and the color-changing material sub-layer 4414. In some embodiments, the first layer, or the first substrate 4410 of the first layer, has an opaque coloring or is coated with an opaque material. In some embodiments, the opaque coloring is any dark color, while in some embodiments, the opaque coloring is substantially black. In some embodiments, the second substrate sub-layer 4416 and the ultra-violet radiation inhibiting sub-layer 4414 are transparent or semi-transparent, allowing the color changing-material sub-layer 4412 to be visible to a viewer of the case.

In some embodiments, the decorative sheeting 4409 (or the substrates 4410, 4416 of the decorative sheeting 4409) are so dimensioned so as to cover substantially all of a surface of a case for a mobile electronic device, such as a mobile phone, music/audio player, laptop computer, tablet computer, and the like. In some embodiments, the dimensions correspond to a back surface of a case for a mobile electronic device.

In some embodiments, the decorative sheeting 4409 further comprises one or more edges defining through-holes between the first and second sides, wherein the one or more through-holes are configured to allow optical access through the sheet by a component of the mobile electronic device. For example, the through-holes are sometimes positioned so that a lens and/or a flash component of a mobile electronic device are not covered by the sheet.

In some embodiments, the decorative sheeting 4409 is combined with a magnetic material 4406 to form a decorative skin for a mobile electronic device case, as described above.

In some embodiments, the range of temperatures between which the thermochromic material changes colors is 32-95 degrees Fahrenheit. In some embodiments, the temperature range is 50-95 degrees Fahrenheit. In some embodiments, the temperature range is 70-140 degrees Fahrenheit. The thermochromic material can be designed to display various colors, ranges of colors, or combinations of colors, in response to different material temperatures. In some embodiments, the material displays only two colors. In some embodiments, the material displays three or more colors. In some embodiments, the material may simultaneously display a first portion having a first color and a second portion having a second color. For example the material may display a blue portion and a green portion. In some embodiments, the material displays multiple portions and multiple colors (e.g., portions displaying blue, green, purple, red, orange, etc.).

Throughout the discussion of thermochromic materials, it should be recognized that a thermochromic material may exhibit a particular color throughout a range of temperatures. In other words, when a material is described as having a color when the material is “at” or when the material “has” a certain temperature, it is understood that the color may appear within a range of temperatures. In some embodiments, a thermochromic material has a first color (e.g., black) when the material is between a first and a second temperature (e.g., between 60-70 degrees Fahrenheit), and a second color (e.g., blue) when the material is between a third and a fourth temperature (e.g., 120-140 degrees Fahrenheit). In some embodiments, the thermochromic material changes fluidly between the first and second color as the temperature rises from the second to the third temperature. A material (or combination of materials) may also exhibit more than one color in response to a single temperature or temperature range. Furthermore, a thermochromic material may exhibit the same or a similar color at two non-contiguous temperature ranges. For example, a thermochromic material may be black when the material is between 60 and 70 degrees Fahrenheit, and black when the material is above 95 degrees Fahrenheit, while displaying various other colors in the intermediate temperature region.

Several types of thermochromic materials exist that are employed in various embodiments of the invention, including thermochromic liquid crystals, and/or Leuco dyes. One of skill in the art will recognize that these substances can be applied to a case in many different ways, and through the use of many different coatings. For example, a thermochromic material can be incorporated into paint, dye, epoxy, ink, wax, film, and/or any other type of coating or covering that will allow the thermochromic material to be seen by a user of the case. In some embodiments, the thermochromic material is embedded in paint or other coating that is applied to a portion of or all of the case. In some embodiments, multiple thermochromic materials are combined in a single paint or coating. For example, a first thermochromic material exhibiting a color change over a first temperature range and a second thermochromic material exhibiting a color change over a second temperature range may be combined to produce a paint or coating exhibiting interesting or desirable color-changing results. In some embodiments, more than two thermochromic materials are used in a single paint or coating.

In some embodiments, the paint or coating is applied substantially only to outer portions of the case, such as those portions of the case that are visible when a mobile electronic device is in the case. In some embodiments, the thermochromic material is embedded in a polymer, plastic, elastomer, or other material that makes up a portion of or all of the case. For example, a surface of a case is sometimes made out of a plastic that has been treated with (or otherwise includes) a thermochromic material. In some embodiments, the entire case is molded from a plastic that has been treated with (or otherwise includes) a thermochromic material.

In some embodiments, the color-changing material used in a case for a mobile electronic device is a photochromic material. Photochromic materials are materials that change color due to a change in the incident light. For instance, a photochromic material may change color when it is exposed to a change in intensity and/or wavelength of light. (As referred to herein, “light” can include electromagnetic radiation of many wavelengths, even those that are outside of the visible spectrum.) In some embodiments, photochromic materials include photochromic substances or molecules such as spiropyrans and spirooxazines, diarylethcnes, azobenzenes, and/or photochromic quinones. Photochromic materials can be used instead of, or in addition to, the thermochromic materials described above. In particular, the disclosure relating to thermochromic materials is understood to apply by analogy to photochromic materials as well. Where the temperature of the thermochromic material is described as the cause of a color change, the wavelength or intensity of incident light on a photochromic material is understood to be the cause of a color change.

In the foregoing description of thermochromic and photochromic materials, both the color-changing substances (e.g., the liquid crystals, Leuco dyes, and/or other color-changing molecules) and the materials that use such substances to display color-changing effects (e.g., film embedded with thermochromic dye, paint with thermochromic liquid crystals, etc) may be referred to as “photochromic materials” and/or “thermochromic materials.” Furthermore, any discussion relating to one type of color-changing material (e.g., thermochromic materials) is understood to apply to similar embodiments using other color-changing materials as well (e.g., photochromic materials).

Also, any of the above described methods are understood to equally apply to methods of manufacturing cases with metameric materials. For example, some embodiments provide methods according to the above descriptions where metameric materials are substituted for color-changing materials and/or thermochromic materials.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

### Method of Manufacturing for Cases

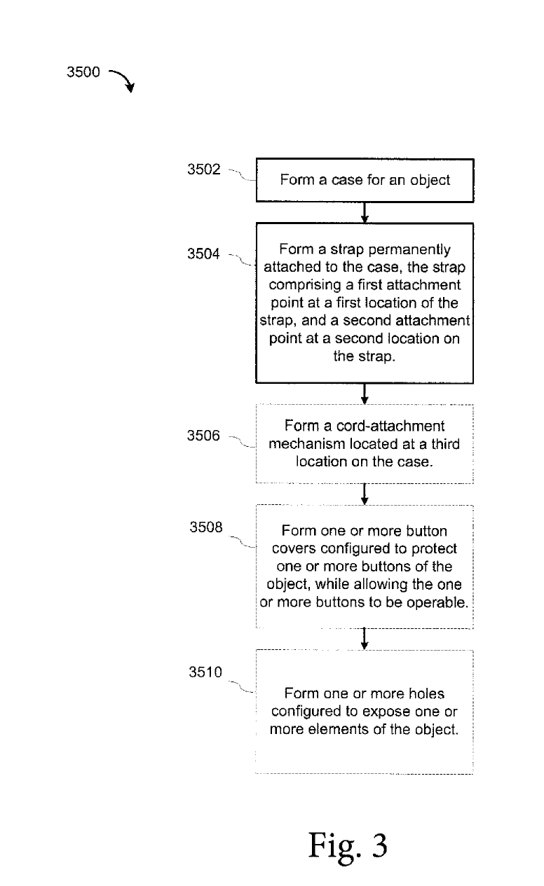

FIG. 3 is a flowchart of a method 3500 for manufacturing a cord management system, according to some embodiments. In some embodiments, the method of manufacturing the cord management system may be performed by a computer system. The computer system forms (3502) a case for an object. The computer system then forms (3504) a strap that is permanently attached to the case. In some embodiments, the strap includes a first attachment point at a first location on the strap and a second attachment point at a second location on the strap. In some embodiments, the strap includes at least two modes of operation. In a first mode of operation, the first attachment point is attached to the second attachment point. In a second mode of operation, the first attachment point is detached from the second attachment point.

In some embodiments, the computer system forms (3506) a cord-attachment mechanism located at a third location on the case. In some embodiments, the computer system forms (3508) one or more button covers configured to protect one or more buttons of the object, while allowing the one or more buttons to be operable. In some embodiments, the computer system forms (3510) one or more holes configured to expose one or more elements of the object.

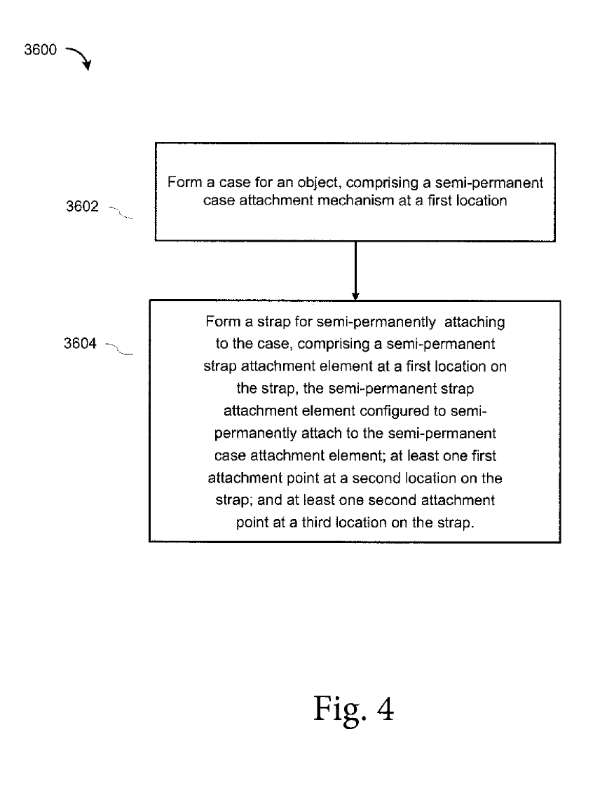

FIG. 4 is a flowchart of a method 3600 for manufacturing a cord management system, according to some embodiments. In some embodiments, the method of manufacturing the cord management system may be performed by a computer system. The computer system forms (3602) a case for an object, comprising a semi-permanent case attachment mechanism at a first location. The computer system then forms (3604) a strap for semi-permanently attaching to the case, comprising at least one semi-permanent strap attachment element at a first location on the strap, the semi-permanent strap attachment element configured to semi-permanently attach to the semi-permanent case attachment element; at least one first attachment point at a second location on the strap; and at least one second attachment point at a third location on the strap. In some embodiments, the strap includes at least two modes of operation. In a first mode of operation, the first attachment point is attached to the second attachment point. In a second mode of operation, the first attachment point is detached from the second attachment point.

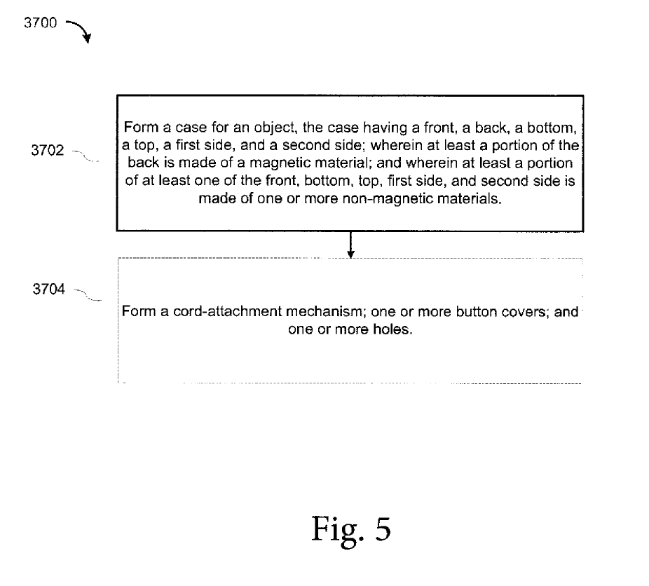

FIG. 5 is a flowchart of a method 3700 for manufacturing a cord management system, according to some embodiments. In some embodiments, the method of manufacturing the cord management system may be performed by a computer system. The computer system forms (3702) a case for an object, the case having a front, a back, a bottom, a top, a first side, and a second side; wherein at least a portion of the back is made of a magnetic material; and wherein at least a portion of at least one of the front, bottom, top, first side, and second side is made of one or more non-magnetic materials.

In some embodiments, the computer system forms (3704) a cord-attachment mechanism; one or more button covers; and one or more holes.

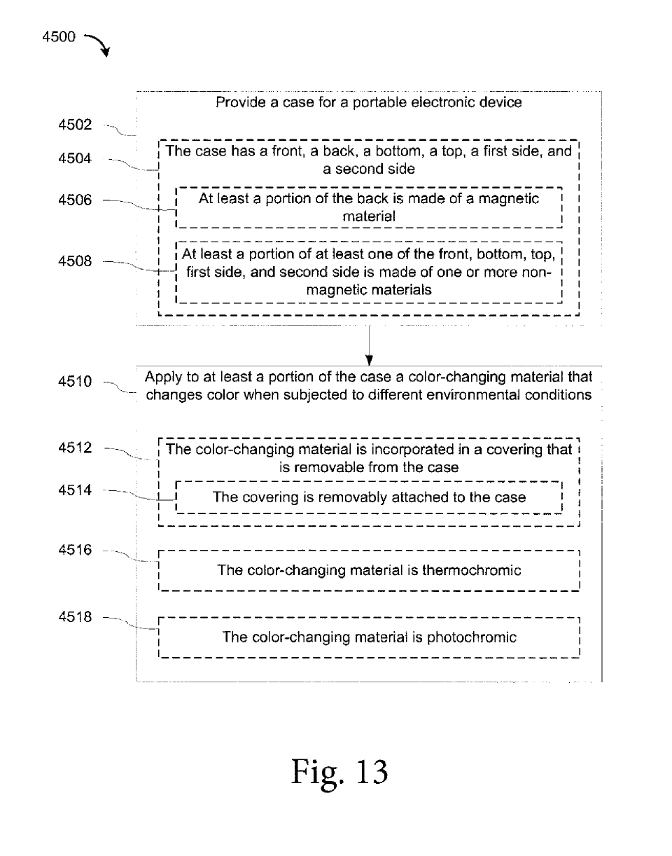

FIG. 13 is a flow chart illustrating a method (4500) of manufacturing a case for a mobile electronic device with a color-changing material, according to some embodiments. A case for a mobile electronic device is provided (4502). In some embodiments, the case has a front, a back, a bottom, a top, a first side, and a second side (4504). In some embodiments, at least a portion of the back is made of a magnetic material (4506). In some embodiments, at least a portion of at least one of the front, bottom, top, first side, and second side is made of one or more non-magnetic materials (4508). A color-changing material that changes color when subjected to different environmental conditions is applied to at least a portion of the case (4510). In some embodiments, the color-changing material is painted on the case. For example, the color-changing material is sometimes sprayed or brushed on the case. In some embodiments, the color-changing material is printed on the case, for example, with an ink jet printing system. In some embodiments, the color-changing material is screen-pressed on the case. In some embodiments, the color changing material is incorporated in a covering that is removably attached to the case (4512), for example, a film and/or a sheet (e.g., the decorative skin 4404, described above). In some embodiments, the covering is removably attached to the case (4514). In some embodiments, the covering is a magnetic sheet that is configured to be removably attached to a case that incorporates magnetic material. Sheets (or skins) are described in greater detail above with reference to FIG. 12A-12B. In some embodiments, the covering is permanently or semi-permanently attached to the case.

In some embodiments, the color-changing material used in the above case is thermochromic (4516), while in other embodiments, the color-changing material is photochromic (4518). In some embodiments. the color-changing material uses both thermochromic and photochromic materials.

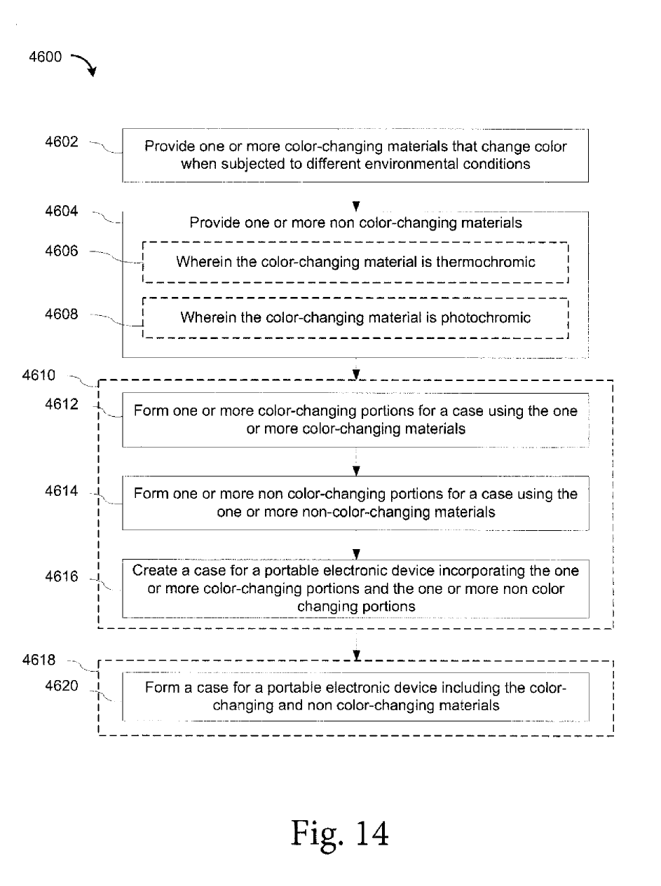

FIG. 14 is a flow chart illustrating a method (4600) of manufacturing a case for a mobile electronic device, according to some embodiments. One or more color-changing materials that change color when subjected to different environmental conditions are provided (4602). One or more non color-changing materials are provided (4604). In some embodiments, the color-changing material is thermochromic (4606). In some embodiments, the color-changing material is photochromic (4608).

In some embodiments, the case is manufactured according to an assembly process (4610). One or more color-changing portions for a case are formed using the one or more color-changing materials (4612). One or more non color-changing portions for a case are formed using the one or more color-changing materials (4614). A case for a mobile electronic device is created, where the case incorporates the one or more color-changing and the one or more non color-changing portions (4616). In some embodiments, the case is created by assembling the color-changing and non color-changing portions.

In some embodiments, the case is manufactured according to a molding process (4618). A case for a mobile electronic device is faulted including the color-changing and non color-changing materials (4620). In some embodiments, the case is formed by injection molding. In some embodiments, the color-changing material is a thermochromic material (such as thermochromic liquid crystals) that is incorporated into a non color-changing polymer that is then injection molded or thermoformed to form a ease for a mobile electronic device.

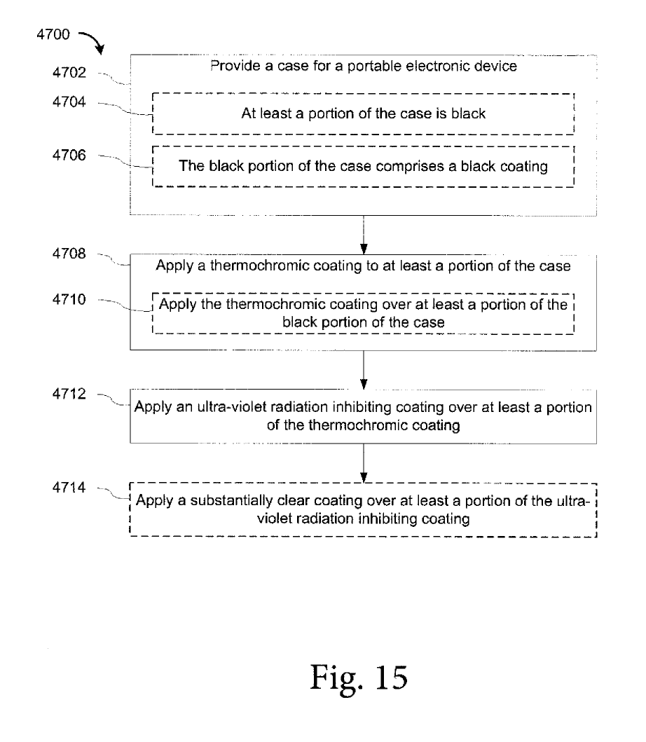

FIG. 15 is a flow chart illustrating a method of manufacturing a case for a mobile electronic device, according to some embodiments (4700). A case for a mobile electronic device is provided (4702). Some thermochromic coatings exhibit improved visual results (i.e., more vivid colors and/or more colors) when they cover or are on top of a dark and/or black surface. Thus, in some embodiments, at least a portion of the case is black (4704). In some embodiments, the black portion of the case comprises a dark and/or black coating, such as a paint and/or a powder coating (4706).

A thermochromic coating is applied to at least a portion of the case (4708). In some embodiments, the thermochromic coating is any of: paint, ink, dye, film, and powder coatings. In some embodiments, the thermochromic coating is sprayed on the portion of the case. In some embodiments, the thermochromic coating is printed on the portion of the case. In some embodiments, the thermochromic coating is a decorative sheeting, e.g., the decorative sheeting 4409.

In some embodiments, an ultra-violet radiation inhibiting coating is applied over at least a portion of the thermochromic coating (4710). This layer helps protect the thermochromic material from degradation due to ultra-violet radiation. In some embodiments, a substantially clear coating is applied over at least a portion of the ultra-violet radiation inhibiting coating (4712). The substantially clear coating is sometimes a hard, protective coating to help prevent the thermochromic and/or the ultra-violet inhibiting coatings from being chipped, peeled, scratched, or otherwise damaged. In some embodiments, an ultra-violet inhibiting material is incorporated into a substantially clear coating, in order to reduce the number of steps in the method (4700). In some embodiments, the ultra-violet inhibiting material is sprayed, printed, screen-pressed, and/or painted on the case.

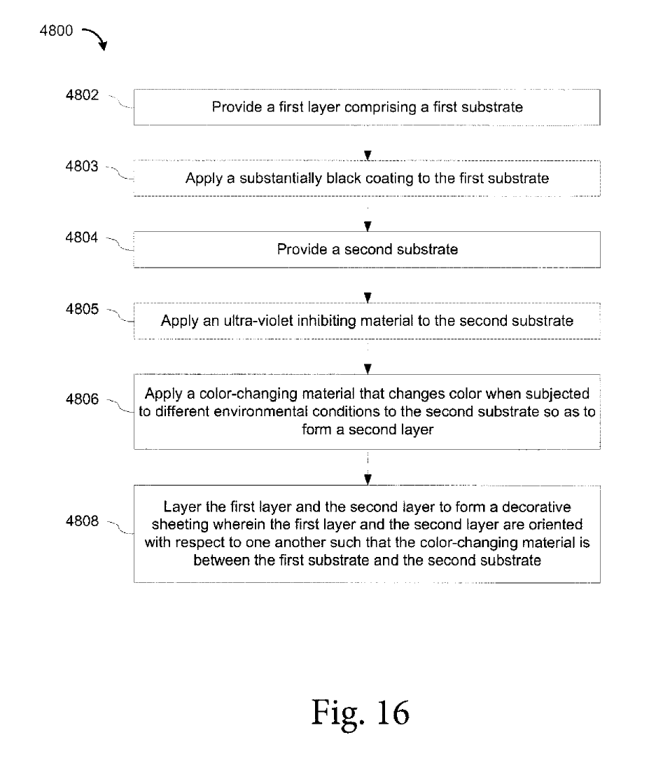

FIG. 16 illustrates a method of manufacturing a decorative sheeting, according to some embodiments (4800). A first layer is provided, where the first layer comprises a first substrate (4802). In some embodiments, a substantially black coating is applied to the first substrate (4803).

A second substrate is provided (4804). In some embodiments, an ultra-violet inhibiting material is applied to the second substrate (4805). In some embodiments, the ultra-violet inhibiting material is a coating that is sprayed or painted on. In some embodiments, the ultra-violet inhibiting material is a film.

A color-changing material is applied to the second substrate (or to the ultra-violet inhibiting material) to form a second layer (4806). The color-changing material is a material that changes color when subjected to different environmental conditions, such as a thermochromic or photochromic material.

The first layer and the second layer are layered to form a decorative sheeting (4808). When the two layers are combined in the layering step (4808), the two layers are oriented with respect to one another such that the color-changing material is between the first substrate and the second substrate.

The ultra-violet inhibiting material applied in step (4805) helps protect the color-changing material from degradation due to ultra-violet radiation. As such, in some embodiments, it is applied to the substrates such that, when the decorative sheeting is applied to an object, the color-changing material is between the object and the ultra-violet inhibiting material.

In the above description, where a material is described as applied to a substrate, one of skill in the art will understood that the material can be applied directly to the substrate, or applied to another sub-layer or material already applied to the substrate.

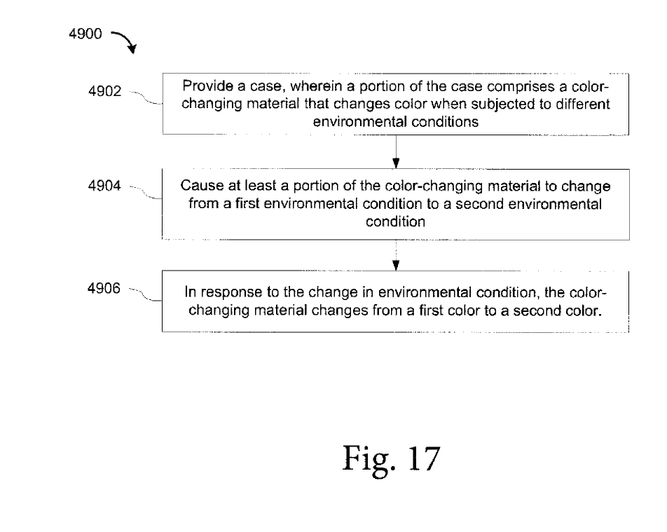

FIG. 17 illustrates a method of using a case for a mobile electronic device, where the case comprises a color-changing material (4900). A case is provided, where a portion of the case comprises a color-changing material that changes color when subjected to different environmental conditions (4902). At least a portion of the color-changing material is changed from a first environmental condition to a second environmental condition (4904). In some embodiments, a user causes the color-changing material to be changed from a first temperature to a second temperature. In some embodiments, the user uses a finger, flashlight. laser, heat pen, and/or heat brush, or other object to cause the temperature change. In response to the change in environmental condition, the color-changing material changes from a first color to a second color (4906).

The methods 3500-3700 and 4500-4800 may be governed by instructions that are stored in one or more computer readable storage mediums and that are executed by one or more processors of one or more computer systems. Each of the operations shown in FIGS. 3-5 and 13-17 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted and/or executable by one or more processors.

Note that although a magnet may be considered a magnetic material, a magnetic material is not necessarily a magnet. Specifically, a magnetic material is a material or composition that produces a magnetic field in response to an applied magnetic field (e.g., a magnetic field produced by a magnet). The magnetic material may include one or more of a ferromagnetic material and a paramagnetic material. Note also that the term “earphones” is used in this specification to refer to any device (e.g., headphones, ear buds. etc.) that an end user places on or in the ears to produce sounds.

Note that the term “connector” is used in this specification to refer to any type of connector or plug. For example, the connector may be an electrical connector (e.g., an audio connector, a video connector, a power connector, a computer connector, etc.) or non-electrical connector.

The magnets described herein may include any element or composition that is capable of producing a magnetic field. For example. the magnets may include one or more of magnetic metallic elements (e.g., iron, cobalt, nickel, etc.), composite magnets (e.g., ceramic or ferrite magnets, alnico magnets, ticonal magnets, injection molded magnets, flexible magnets), rare earth magnets (e.g., samarium-cobalt magnets, neodymium-iron-boron magnets, etc.), electromagnets, sets of any of these magnets, or any material or composition that produces a magnetic field. In some embodiments, the magnets are Neodymium magnets. In some embodiments, the Neodymium magnets are a grade N42.

Note that the combination of the grade (i.e., the composition of materials, wherein a higher number for the grade indicates a higher magnetic strength per unit volume), the diameters, the shape, and the thickness of a magnet determines the magnetic strength of the magnet. The magnetic strength of a larger magnet (e.g., larger surface area, diameter, and/or thickness) having a lower grade (e.g., lower “N” number) may have greater magnetic strength than a smaller magnet with a higher grade. For example, Neodymium magnets have the following grades, ordered from lowest to highest strength, N28, N30, N33, N35, N38, N40, N42, N45, N48, N50, and N52. A large N28 magnet may be stronger than a small N52 magnet.

Note that a magnetic material is a material or composition that produces a magnetic field in response to an applied magnetic field. The magnetic material may include one or more of a ferromagnetic material and a paramagnetic material. In some embodiments, the magnetic material is low-carbon steel. Aly combination of magnets and magnetic material that allows for the magnetic attachments described herein to function may be used.

Note that a magnet or magnetic material may be attached to an electronic device using adhesives, suction devices (e.g., suction cups), Velcro, van der Waals force attachment mechanisms (e.g., “Gecko” tape), snaps, buttons, and the like. Also note that the magnetic material may be molded into the electronic device, a back panel of the electronic device, and/or a case for the electronic device.

Note that the term “magnetically attached,” when applied to two magnets, refers to two magnets being attached to each other by an attractive magnetic force between the two magnets. In contrast, the term “magnetically detached,” when applied to two magnets, refers to two magnets that are no longer attached to each other. Although the two magnets may no longer be magnetically attached to each other, the two magnets may still be “magnetically coupled” to each other. In other words, each magnet may feel a magnetic force generated by the magnetic field of the other magnet. This magnetic force is a function of the distance between the two magnets.

Also note that this specification refers to two magnets (or magnets and magnetic materials) being “magnetically attached” to each other even if the magnets are separated by intermediary materials. When a magnet is magnetically attached to another magnet and a decoupling force that is greater than or equal to the predefined threshold is exerted against the predefined attractive magnetic force between the magnets, the magnets become magnetically detached from each other.

Note that the term “case” refers to any type of material that covers or partially covers the object. For example, the case may include, but is not limited to flip case, a zipper case, a skin, an open-faced case, and the like.

The foregoing description, for purpose of explanation, has been described with reference to specific embodiments. However, the illustrative discussions above are not intended to be exhaustive or to limit the disclosed ideas to the precise forms disclosed. Many modifications and variations are possible in view of the above teachings. The embodiments were chosen and described in order to best explain the principles and practical applications of the disclosed inventions, to thereby enable others skilled in the art to best utilize them in various embodiments with various modifications as are suited to the particular use contemplated.

1. A magnetic housing for a mobile electronic device having one or more internal antennas, comprising;
a magnetic back configured to:
cover at least a portion of a back of the mobile electronic device; and
magnetically couple with one or more magnetic attachments;
an encapsulating material connected to the magnetic back and configured to cover and protect the mobile electronic device; and
an aperture configured to expose a camera lens of the mobile electronic device;
wherein the encapsulating material is configured to cover the one or more internal antennas while the mobile electronic device is enclosed in the housing; and
wherein the magnetic back is configured so as to not cover the one or more internal antennas while the mobile electronic device is enclosed in the housing.

2. The magnetic housing of claim 1, wherein the encapsulating material encapsulates the magnetic back.

3. The magnetic housing of claim 1, wherein the encapsulating material comprises a pliable material.

4. The magnetic housing of claim 1, wherein the encapsulating material comprises a rigid material.

5. The magnetic housing of claim 1, wherein the encapsulating material is configured to secure the magnetic hack against the back of the mobile electronic device while the mobile electronic device is enclosed in the housing.

6. The magnetic housing of claim 1, further comprising a second aperture configured to expose a touch screen of the mobile electronic device while the mobile electronic device is enclosed in the housing.

7. The magnetic housing of claim 1, further comprising one or more pliable button covers, each connected to the encapsulating material and configured to enable user interaction with a respective button of the mobile electronic device through the pliable button cover.

8. The magnetic housing of claim 1, wherein the aperture is further configured to expose a flash component of the mobile electronic device while the mobile electronic device is enclosed in the housing.

9. The magnetic housing of claim 1, wherein the magnetic back comprises a ferromagnetic material.

10. The magnetic housing of claim 1, wherein the magnetic back comprises a paramagnetic material.

11. The magnetic housing of claim 1, further comprising the one or more magnetic attachments configured to magnetically attach to the magnetic back.

12. The magnetic housing of claim 1, wherein the magnetic back has a first coloring, distinct from a coloring of the encapsulating material,

13. The magnetic housing of claim 1, further comprising a second aperture configured to expose one or more electrical connectors of the mobile electronic device,

14. The magnetic housing of claim 1, further comprising a coating applied to the magnetic back, the coating configured to protect the magnetic hack from scratching,

15. The magnetic housing of claim 1, wherein the encapsulating material is slidably connected to the magnetic back.

16. The magnetic housing of claim 15, wherein the encapsulating material includes a pocket configured to receive the magnetic back.

17. The magnetic housing of claim 15, wherein the encapsulating material a framing portion configured to receive the magnetic back, wherein the framing portion exposes a middle portion of the magnetic back while the magnetic back is inserted.
